(19) United States
(12) Patent Application Publication
(10) Pub. No.: US 2024/0339654 A1
(43) Pub. Date: Oct. 10, 2024

(54) SOLID STATE ELECTROLYTES FOR HIGH-RATE ALL-SOLID-STATE METAL BATTERIES

(71) Applicant: BOARD OF REGENTS, THE UNIVERSITY OF TEXAS SYSTEM, Austin, TX (US)

(72) Inventors: John B. GOODENOUGH, Austin, TX (US); Yutao LI, Austin, TX (US); Biyi XU, Austin, TX (US)

(21) Appl. No.: 18/287,393

(22) PCT Filed: Apr. 18, 2022
(86) PCT No.: PCT/US2022/025195

§ 371 Date: Oct. 18, 2023

Related U.S. Application Data
(60) Provisional application No. 63/176,661, filed on Apr. 19, 2021.

(51) Int. Cl. H01M 10/056

(52) U.S. Cl. CPC H01M 10/056; H01M 2300/0071; H01M 2300/0082; H01M 2300/0091

(57) ABSTRACT

Disclosed is a solid-state ion-conducting composite electrolyte comprising: a) a polymer host; b) an alkali metal salt comprising a monovalent metal cation, wherein the alkali metal salt is dispersed in the polymer host; and c) a functional additive comprising at least one divalent and/or trivalent metal cation; wherein an ionic radius of the at least one divalent and/or trivalent metal cation of the functional additive is substantially similar to an ionic radius of the monovalent metal cation of the alkali metal salt; and wherein the functional additive is substantially dissolved within the polymer host; and wherein the solid-state ion-conducting composite electrolyte has an ionic conductivity of at least about 10⁻⁴ S/cm at room temperature.

### CROSS-REFERENCE TO RELATED APPLICATIONS

This application claims the benefit of U.S. Provisional Application No. 63/176,661 filed Apr. 19, 2021, the content of which is incorporated herein by reference in its entirety.

### STATEMENT ACKNOWLEDGING GOVERNMENT SUPPORT

This invention was made with government support under Grant No. DE-EE0007762 awarded by the Department of Energy. The government has certain rights in the invention.

### TECHNICAL FIELD

This application relates generally to a stable solid-state-electrolyte with functional additives for all-solid-state metal batteries.

### BACKGROUND

Rechargeable (secondary) lithium-ion batteries are widely utilized in consumer electronic devices such as cell phones and laptop computers owing, in part, to their high energy density. Rechargeable lithium-ion batteries are also useful in power-intensive applications, such as in electric vehicles and power tools. Additional uses for rechargeable lithium-ion batteries, such as in energy grid storage, are possible. Although rechargeable batteries with other alkali-metal ions, such as sodium and potassium, are less widespread, they may be used in many of the same applications as lithium-ion batteries.

Combining a thin Li⁺-conducting solid-state electrolyte with the high capacity and low electrochemical potential of a metallic lithium anode allows for all-solid-state Li-metal batteries to achieve much higher energy densities than the widely commercially adopted, current state-of-the-art, rechargeable Li-ion batteries that use a graphite anode with a liquid electrolyte. Replacing the flammable and toxic organic liquid electrolyte with a non-flammable solid-state electrolyte also improves the safety of rechargeable lithium-based batteries. Lithium solid-state electrolytes are the critical component of solid-state batteries and have been widely investigated in the last decade, leading to the discovery of materials with higher Li⁺-conductivity than traditional organic liquid electrolytes such as the argyrodite-structured sulfides, Li_{6-y}P_{5-y}X_{1+y} (X═Cl, Br).

However, it is known that the most solid-state electrolytes, such as oxides, sulfides, halides, and polymers, have limited electrochemical windows and react with lithium metal to form a solid electrolyte interphase (SEI). However, the formation of the SEI is difficult to control. Inhomogeneities at the Li/solid-electrolyte interface, with or without an SEI, can elicit an irregular lithium plating that leads to dendrite formation. Moreover, the rapid growth of lithium dendrites results in a large volume change of the metallic lithium anode and loss of the physical contact between the solid-state electrolyte and the lithium metal, thereby significantly increasing the total resistance of the cell and reducing its cycle life.

The current strategies to address these challenges include using stack pressure that is expected to suppress the volume change of Li metal and maintain good contact between lithium metal and solid-state electrolytes. However, it was found that this approach has its own challenges as it can lower the energy density of the battery owing to the extra weight the pressure apparatus adds to the system.

Therefore, to obtain competitive all-solid-state lithium-metal batteries without external pressure, the composition and ionic conductivity of the SEI layer must be optimized to suppress lithium dendrite nucleation as well as to improve the wettability of the solid-state electrolyte by a lithium-metal anode.

Thus, new approaches to provide stable solid-state electrolytes that address these needs are needed. Electrochemical cells utilizing these new stable solid-state electrolytes and having a high areal capacity and a prolonged cycling lifespan are also needed. These needs and other needs are at least partially satisfied by the present disclosure.

### SUMMARY

The present disclosure is directed to a solid-state ion-conducting composite electrolyte comprising: a) a polymer host; b) an alkali metal salt comprising a monovalent metal cation, wherein the alkali metal salt is dispersed in the polymer host; and c) a functional additive comprising at least one divalent and/or trivalent metal cation; wherein an ionic radius of the at least one divalent and/or trivalent metal cation of the functional additive is substantially similar to an ionic radius of the monovalent metal cation of the alkali metal salt; and wherein the functional additive is substantially dissolved within the polymer host; and wherein the solid-state ion-conducting composite electrolyte has an ionic conductivity of at least about 10⁻⁴ S/cm at room temperature.

Also disclosed herein are aspects wherein the polymer host comprises poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof.

Also disclosed herein are aspects where the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, or a combination thereof.

In still further aspects, the at least one divalent and/or trivalent metal cation of the functional additive comprises one or more of Mg²⁺, Ba²⁺, Sc²⁺, Zn²⁺, Sn²⁺, Al³⁺, or Y³⁺.

While in other exemplary aspects, as described herein, the inorganic filler comprises ceramic fillers, Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, Li₃N, garnet Li₇La₃Zr₂O₁₂, perovskite Li_{0.33}La_{0.56} TiO₃, NASICON Li_{1.3}Al_{0.3}Ti_{1.7}(PO₄)₃, halide Li₃YCl₆, argyrodite Li₆PS₅Cl, or any combination thereof.

Further disclosed herein are aspects directed to an electrochemical cell comprising: a) a metal anode comprising an electrochemically active surface; b) a solid-state ion-conducting composite electrolyte comprising: i) a polymer host; ii) an alkali metal salt comprising a monovalent metal cation, wherein the alkali metal salt is dispersed in the polymer host; and iii) a functional additive comprising at least one divalent and/or trivalent metal cation; wherein an ionic radius of the at least one divalent and/or trivalent metal cation of the functional additive is substantially similar to an ionic radius of the monovalent metal cation of the alkali metal salt; and wherein the functional additive is substantially dissolved within the polymer host; and wherein the solid-state ion-conducting composite electrolyte has an ionic conductivity of at least about 10⁻⁴ S/cm at room temperature; and wherein the ion-conductive composite electrolyte is flexible and is in electrical communication with the metal anode; and c) a solid electrolyte interphase layer formed in-situ and is disposed on the electrochemically active surface of the metal anode.

In still further aspects, the solid electrolyte interphase layer is an electronic insulator, which exhibits an electrochemical window from 0 V to about 6.5 V vs. Li⁺/Li reference electrode. In yet further aspects, the solid electrolyte interphase layer is formed in-situ and has a thickness from about 10 to about 100 nm. In still further aspects, the disclosed electrochemical cell comprises a cathode.

In some aspects, the disclosed herein electrochemical cell can exhibit a high critical current density of about 0.4 to about 2 mA cm⁻². While in other aspects, the disclosed herein electrochemical cell can exhibit a high areal capacity from about 0.1 mAh cm⁻² to about 0.5 mAh cm⁻². In still further aspects, the disclosed herein electrochemical cell is a battery.

Also disclosed herein are methods comprising: a) forming a mixture of a polymer host, an alkali metal salt, and a functional additive in a solvent, wherein the alkali metal salt comprises a monovalent cation; wherein the functional additive comprises at least one divalent and/or trivalent metal cation and wherein an ionic radius of the metal cation of the functional additive is substantially similar to an ionic radius of the monovalent metal cation of the alkali metal salt, and b) removing the solvent to form a flexible solid-state ion-conducting composite electrolyte comprising the alkali metal salt and the functional additive that is substantially dispersed within the polymer host; wherein the flexible solid-state ion-conducting composite electrolyte has an ionic conductivity of at least about 104 S/cm at room temperature.

Also disclosed here are methods of forming a battery comprising: disposing any of the disclosed herein solid-state ion-conducting composite electrolytes, an electrochemically active surface of a metal anode, and a cathode.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIGS. 1A-1B depict a schematic of the composite electrolyte (FIG. 1A) and XRD patterns of the composite electrolytes as well as Al₂O₃ and Mg(ClO₄)₂ (FIG. 1B).

FIGS. 2A-2D depict Li⁺ transport in CPE-xMC (x=0, 0.5, 1, 2 wt %). FIG. 2A shows FTIR spectra of CPE-0MC and CPE-05MC membranes at room temperature.

FIG. 2B shows Li⁺ conductivity of CPE-xMg(ClO₄)₂ at 35° C. FIG. 2CA shows high-resolution ⁶Li MAS NMR spectra of CPE-0MC and CPE-05MC. FIG. 2D shows snapshots of the molecular dynamic simulation of Li-ion coordination in CPEs with Mg(ClO₄)₂. The calculations were performed with an Mg²⁺ additive concentration of 0.5 wt % and EO/LiTFSI ratio of 10:1 at 600 K for 400 ns.

FIGS. 3A-3D show conductivity results for the membranes without LiTFSI. Li salts-free CPE-05MC was made of PEO, 15 wt % Al²O₃ nanofiller, and 0.5 wt % Mg(ClO₄)₂ FIG. 3A shows impedance plots of the composite electrolyte without LiTFSI at 60° C. FIG. 3B shows an Arrhenius plot of SS/PEO—Al₂O₃—Mg(ClO₄)₂/SS in the temperature range of 60˜80° C. FIG. 3C shows the impedance plots of the Mg/Mg cell before and after DC polarization. Mg electrode shows a feature of the blocking electrode for PEO—Al₂O₃—Mg(ClO₄)₂ composite electrolyte. FIG. 3D shows time-dependence of current under 10 mV polarization for Mg/Mg symmetric cell employing PEO—Al₂O₃—Mg(ClO₄)₂ composite electrolyte.

FIGS. 4A-4D show a schematic illustration of the interactions between PEO, TFSI⁻ and Li, Mg ions. Bond distances (in Å) for Mg²⁺ (FIG. 4A), Li⁺ with the TFSI⁻ anions, and PEO host at 600 K in CPE-05MC (FIG. 4B, 4C, 4D), respectively.

FIGS. 5A-5H depict Li/Li symmetric cell performance of CPE-MC electrolytes. FIG. 5A shows the interfacial resistance of the Li/Li symmetric cells and the transference number of each CPE-xMC electrolyte. FIG. 5B shows the long-term galvanostatic cycling profile of the Li/CPE-05MC/Li cell at various current densities measured at 55° C. FIG. 5C shows a rate performance test of the Li/CPE-05MC/Li cell to determine its critical current density with a stripping/plating period of 5 min. Cross-sectional synchrotron X-ray tomography images showing Li/CPE-05MC/Li (FIG. 5D) and Li/CPE-0MC/Li cells (FIG. 5E) after cycling. FIG. 5F shows 3D reconstructions of the Li/CPE-05MC/Li and FIG. 5G shows Li/CPE-0MC/Li symmetric cell samples, while FIG. 5H shows a schematic of the cell: 5-solid-state electrolyte in one aspect; 6—an in-situ formed interface; 7—a metal anode.

FIGS. 6A-6D depict a steady-state current with time under 10 mV DC polarization for symmetric cells. FIG. 6A shows a steady-state current under 10 mV polarization for CPE-05MC cycling in Li/Li symmetric cell. FIG. 6B shows EIS plots before and after Li/Li cell polarization. FIG. 6C shows a steady-state current of Mg/CPE-05MC/Mg symmetric cell under 10 mV polarization. FIG. 6D shows the impedance plots of the Mg/CPE-05MC/Mg symmetric cell before and after DC polarization. It should be noted that the Mg/Mg symmetric cell showed negligible current response under 10 mV amplitude, and the Nyquist plot exhibited a diffusion tail in the full frequency range, indicating that Mg²⁺ ions in the CPE-05MC cannot be transferred in Mg/Mg symmetric cells.

FIGS. 7A-B depict a voltage profile of galvanostatic charge-discharge cycles in symmetric cells. FIG. 7A shows a voltage profile of CPE-0MC at 0.2 and 0.4 mA cm⁻² with an areal capacity of 0.1 mAh cm⁻² at 55° C. Short-circuit was observed at 0.4 mA cm⁻². FIG. 7B shows galvanostatic charging tests of the symmetric cell at a current density of 0.1 mA cm⁻² at 55° C. The voltage drops indicate the dendrite penetration of the cell, and Mg(ClO₄)₂ additive extends the short-circuit time at 0.1 mA cm⁻² to 32 h.

FIGS. 8A-8C depict the voltage profile of galvanostatic charge-discharge cycles in Li/CPE-05MC/Li symmetric cells. Voltage profiles of Li/CPE-05MC/Li cycling at 1.2 mA cm⁻² for 100 h with an areal capacity of 0.1 mAh cm⁻² (FIG. 8A); 0.4 and 0.6 mA cm⁻² for 200 h with an areal capacity of 0.2 mAh cm⁻² (FIG. 8B), and 0.4 mA cm⁻² for 80 h with an areal capacity of 0.5 mAh cm⁻² (FIG. 8C) respectively.

FIGS. 9A-9C show the rate performance of the Li/Li symmetric cells measured under different current densities. FIG. 9A shows CPE-05MC and CPE-0MC for 30 min per half cycle. The CPE-05MC electrolyte is stable under a critical current density of 1.2 mA cm⁻² (0.6 mAh cm⁻²), while CPE-0MC electrolyte is short-circuited under a critical current density of 0.4 mA cm⁻² (0.2 mAh cm⁻²). FIG. 9B shows CPE-05MC and FIG. 9C shows CPE-0MC for 60 min per half cycle.

FIGS. 10A-10B show microtopography of lithium metal surfaces after being cycled at 0.1 mAh cm⁻² for 10 cycles. FIG. 10A shows Li/CPE-05MC/Li and FIG. 10B shows Li/CPE-0MC/Li symmetric cells.

FIGS. 11A-11H show the characterization of the Li/CPE-xMC interface. FIGS. 11A-B show XPS spectra of Mg 1s and Cl 2p core levels of the CPE-05MC electrolyte before and after cycling (FIG. 11A), and the lithium metal cycled with CPE-OMC and CPE-05MC, respectively (FIG. 11B). FIGS. 11C-11D show TOF-SIMS depth profiles of representative species of the SEI formed at the Li/CPE-05MC interface after cycling in the Li/Li cell. The LiMgCl₄⁻ and Li₂F⁻ signals were selected, representing Li₂MgCl₄ and LiF, which are the main compounds of the investigated SEI layer. FIG. 11E shows 3D visual renderings of the TOF-SIMS depth profiles presented in (FIGS. 11C-11D). FIG. 11F shows computed reduction and oxidation energy levels of the PEO, LiTFSI, Mg(ClO₄)₂, and LiF. FIGS. 11G-11H show the migration pathway and the corresponding energy barrier for diffusion of Li⁺ in Li_{31/16}MgCl₄.

FIG. 12 shows XPS spectra at Li 1s core level of Li metal after cycling with CPE-0MC and CPE-05MC. Peaks at 56.5 and 50 eV represent LiCl-related compound and Mg²⁺ signals, respectively.

FIGS. 13A-13F show cycling performance of CPE-05MC in all-solid-state LiFePO₄/Li and LiNi_{0.8}Mn_{0.1}Co_{0.1}O/Li cells at 55° C. FIG. 13A shows an electrochemical impedance plot of the all-solid-state LiNi_{0.8}Mn_{0.1}Co_{0.1}O₂/CPE-05MC/Li cell. FIGS. 13B-13C show charge/discharge voltage profiles and FIGS. 13D-13E show capacity retention and cycling efficiency of the LiFePO₄/CPE-05MC/Li cell and LiNi_{0.8}Mn_{0.1}Co_{0.1}O₂/CPE-05MC/Li cell under various current densities, respectively; FIG. 13F shows a schematic of the components in an all-solid-state cell.

FIG. 14 shows an electrochemical impedance plot of the all-solid-state LiFePO₄/CPE-05MC/Li cell.

FIGS. 15A-15B depicts a schematic view of synchrotron X-ray tomography. FIG. 15A shows a schematic of the BAMline end station dedicated for synchrotron X-ray imaging and FIG. 15B shows a proof-of-concept electrochemical cell, which is fully compatible with X-ray imaging

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a functional additive” includes two or more such functional additives, reference to “a battery” includes two or more such batteries, and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Solid-State Electrolyte

As disclosed above, the current disclosure is directed to a solid-state ion-conducting composite electrolyte comprising: a) a polymer host; b) an alkali metal salt comprising a monovalent metal cation, wherein the alkali metal salt is dispersed in the polymer host; and c) a functional additive comprising at least one divalent and/or trivalent metal cation; wherein an ionic radius of the at least one divalent and/or trivalent metal cation of the functional additive is substantially similar to an ionic radius of the monovalent metal cation of the alkali metal salt; and wherein the functional additive is substantially dissolved within the polymer host; and wherein the solid-state ion-conducting composite electrolyte has an ionic conductivity of at least 10⁻⁴ S/cm at room temperature.

The solid-state ion-conducting electrolyte of this disclosure offers multiple advantages over the known in the art liquid or solid-state electrolyte.

Compared to the fragile, fast Li⁺-conducting ceramics, electrolytes based on the polymers are flexible and can be prepared as a thin membrane to ensure a better physical contact with the electrodes. Each of these qualities helps reduce the interfacial resistance in a battery and allow all-solid-state Li-metal batteries with a polymer electrolyte that can be cycled without externally applied pressure. Moreover, the raw materials and manufacturing costs of polymer electrolytes are much lower than those of oxide and sulfide electrolytes, partially due to the similarity between the preparation process of polymer-based all-solid-state batteries and existing lithium-ion battery technology.

However, low ionic conductivity and a fast lithium dendrite permeation limit the large-scale applicability of these materials in all-solid-state Li-metal batteries. The conventional, low-cost poly(ethylene oxide) (PEO)-based composite polymer electrolytes exhibit relatively high ionic conductivity at room temperature (10⁻⁵ up tp 10⁻⁴ S cm⁻¹), but their low critical current density promotes quick lithium dendrite growth at current densities above 0.3 mA cm⁻².

The disclosed herein electrolytes exhibit high ionic conductivity and allow prolonged cycling of the electrochemical cells at relatively high current densities and areal capacities, thus substantially delaying potential dendrite-caused failures.

The ion-conducing composite electrolytes of the present disclosure can exhibit ionic conductivity of at least about 10⁻⁴ S/cm at room temperature. In some aspects, the ionic conductivity of the disclosed solid-state electrolyte can be about 1×10⁻⁴ S/cm, about 1.2×10⁻⁴ S/cm, about 1.5×10⁻⁴ S/cm, about 1.7×10⁻⁴ S/cm, about 2×10⁻⁴ S/cm, about 2.1×10⁻⁴ S/cm, or about 2.2×10⁻⁴ S/cm at room temperature.

The disclosed herein solid-state electrolytes comprise an alkali metal salt comprising a monovalent metal cation, wherein the alkali metal salt is dispersed in the polymer host. In some aspects, the alkali metal salt can be present in any amount that allows for achieving the desired results. In yet other aspects, the alkali metal salt can be present in an amount from greater than 0 wt % to less than 100 wt % based on the weight of the polymer host. In still further aspects, the alkali metal salt can be present in an amount from about 1 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, 70 wt %, about 75 wt %, about 80 wt %, about 85 wt %, about 90 wt %, or about 95 wt % based on the weight the polymer host. In still further aspects, the alkali metal salt can be present in an amount from about 30 wt % to about 80 wt %, including exemplary values of about 35 wt %, about 40 wt %, about 45 wt %, about 50 wt %, about 55 wt %, about 60 wt %, about 65 wt %, 70 wt %, and about 75 wt % based on the weight the polymer host.

In some exemplary and unlimiting aspects, the ratio of the host polymer, for example, PEO, to an alkali metal salt can be anywhere between about 20:1 to about 1:1, including exemplary values of about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, and about 2:1.

In further aspects, the alkali metal salt can comprise any of the alkali metal salt suitable for the desired application. It is also understood that the alkali metal salt composition can be defined by the final use. For example, if the solid-state electrolyte is designed for use in a lithium electrochemical cell, the alkali metal salt can comprise Li cations. However, it is also understood that if the solid-state electrolyte is designed for use in sodium or potassium electrochemical cells, the alkali metal salt can comprise Na or K cations

In still further aspects, the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, or a combination thereof.

In still further aspects, the alkali metal is homogeneously dispersed within the polymer host.

In still further aspects, the functional additive can be present in an amount from greater than 0 wt % to about 5 wt % based on the weight of the polymer host, including exemplary values of about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.2 wt %, about 1.5 wt %, about 1.8 wt %, about 2.0 wt %, about 2.2 wt %, about 2.5 wt %, about 2.8 wt %, about 3.0 wt %, about 3.2 wt %, about 3.5 wt %, about 3.8 wt %, about 4.0 wt %, about 4.2 wt %, and about 4.8 wt % based on the weight of the polymer host.

In certain aspects, and as disclosed herein, the functional additive can comprise at least one divalent and/or trivalent metal cation. In such exemplary aspects, the ionic radius of the at least one divalent and/or trivalent metal cation of the functional additive is substantially similar to the ionic radius of the monovalent metal cation of the alkali metal salt. For example, and without limitations, if the monovalent metal cation of the alkali metal salt is Li, then the ionic radius of the metal cation of the functional additive is substantially similar to the ionic radius of Li. However, in other aspects, if the monovalent metal cation of the alkali metal salt is Na or K, then the ionic radius of the metal cation of the functional additive is substantially similar to the ionic radius of Na or K.

In certain aspects, the at least one divalent and/or trivalent metal cation of the functional additive comprises one or more of Mg²⁺, Ba²⁺, Sc²⁺, Zn²⁺, Sn²⁺, Al³⁺, or Y³⁺. In yet still further aspects, the functional additive is homogeneously dispersed within the polymer host. In still further aspects, the metal cation of the functional additive is immobile in the polymer host. It is understood that the term “immobile” refers to substantially no transfer of the metal cation of the functional additive within the polymer host.

In still further aspects, the functional additive is also present as a salt, and the metal cation of the functional additive is accompanied by a counter anion. It is understood that any counter anion that provides for the desired result can be used. In some exemplary and unlimiting aspects, the counter anion can be selected from halides, Cl⁻, ClO₄⁻, ClO₃⁻, I⁻, IO₃⁻, AlCl₄⁻, BCl₄⁻, BrO₃⁻, or a combination thereof.

In still further exemplary and unlimiting aspects, the functional additive can be Mg(ClO₄)₂. It was found that these functional additives can increase the ionic conductivity of the polymer host and assist in constructing a Li⁺-conducting SEI layer at the Li/polymer interface in the Li electrochemical cells.

Without wishing to be bound by any theory, it was found that Mg²⁺ cations, which have an ionic radius similar to that of lithium and strong ionic polarity, can regulate Li⁺ coordination environments within the solid-state electrolyte, which promotes the dissociation of lithium salt ion pairs and increases the concentration of mobile Li-ions. Still, further, it was found that a more uniform SEI layer containing Li₂MgCl₄/LiF salt that is a Li⁺ conductor and an electronic insulator can be formed at the Li/electrolyte interface in an electrochemical cell, as discussed below.

In some aspects, the functional additives of the present disclosure can decrease the crystallization of the polymer host and homogenizes the current deposition when the electrolyte is used in the electrochemical cell. The functional additive used in the present disclosure can also react with the alkali metal and form a homogeneous interfacial layer with the high ionic conductivity and low electronic conductivity at the interfaces to regulate the current deposition effectively, as is discussed below.

Ionic component additives for use in the polymer matrix, according to the disclosure, include, but are not limited to, various halides, including Cl for example, ClO₄⁻, ClO₃⁻, I⁻, IO₃⁻, AlCl₄⁻, BCl₄⁻, BrO₃⁻, anions. In such aspects, the functional additives can, for example, comprise Mg(ClO₄)₂, Sc(ClO₄)₂, or Al(ClO₄)₃. Typically, one or more functional additives in the composite electrolyte can form halides, such as LiF, LiCl, LiF-related, or LiCl-related components within the interfacial layer.

In still further aspects, the solid-state ion-conducting composite electrolyte can comprise any polymer host that would provide for the desired results. In some exemplary and unlimiting aspects, the polymer host can comprise poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof. However, it is understood that these polymers are only exemplary, and any polymer whose conductivity can be improved by the functional additives and alkali metal salts as disclosed herein can also be used. In still further aspects, the polymer host can comprise a mixture of the polymers, for example, and without limitations, such as a cross-linked polymer blend comprising PEO or PEO-PVDF may be selected.

In still further aspects, the solid-state ion-conducting composite electrolytes of the present disclosure can further comprise an inorganic filler. The inorganic filler can be present in any amount to provide the desired results. In some aspects, the inorganic filler is present in an amount from greater than 0 wt % to about 50 wt % based on the weight of the polymer host. In some aspects, the inorganic filler is present in an amount of about 0.5 wt %, about 1 wt %, about 5 wt %, about 10 wt %, about 15 wt %, about 20 wt %, about 25 wt %, about 30 wt %, about 35 wt %, about 40 wt %, about 45 wt %, or about 50 wt % based on the weight of the polymer host. Yet in still further aspects, the inorganic filler is present in an amount from greater than 0 wt % to about 30 wt %, including exemplary value of about 0.2 wt %, about 0.5 wt %, 0.8 wt %, about 1 wt %, about 2 wt %, about 5 wt %, about 8 wt %, about 10 wt %, about 12 wt %, about 15 wt %, about 18 wt %, about 20 wt %, about 22 wt %, about 25 wt %, and about 28 wt % based on the weight of the polymer host.

In further aspects, any inorganic filler that provides the desired result can be utilized. In some exemplary and unlimiting aspects, the inorganic filler can comprise ceramic fillers, Li⁺-insulators such as Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, or Li⁺-conductors such as Li₃N, garnet Li₇La₃Zr₂O₁₂, perovskite Li_{0.33}La_{0.56}TiO₃, NASICON Li_{1.3}Al_{0.3}Ti_{1.7}(PO₄)₃, halide Li₃YCl₆, argyrodite Li₆PS₅Cl, or any combination thereof.

In still further aspects, the monovalent cation of the alkali metal salt can have a transference number in the disclosed electrolyte from about 0.25 to about 0.4, including exemplary values of about 0.26, about 0.27, about 0.28, about 0.29, about 0.3, about 0.31, about 0.32, about 0.33, about 0.34, about 0.35, about 0.36, about 0.37, about 0.38, and about 0.39.

In still further aspects the disclosed herein, the solid-state ion-conducting composite electrolyte exhibits an electronic conductivity of less than about 10⁻⁹ S cm⁻¹, less than about 10⁻¹⁰ S cm⁻¹, or even less than about 10⁻¹¹ S cm⁻¹.

In still further aspects, the functional additive is configured to interact with one or more oxygen atoms present in the polymer host. While yet still in further aspects, the functional additive can also interact with one or more anions of the alkali metal salt. For example, and without limitations, the divalent and/or trivalent cations with a similar ionic radius to that of lithium ions can coordinate with the oxygen from the polymer host and stabilize the anions from the lithium salts; additive Cl⁻ or ClO₄⁻, ClO₃⁻, I⁻, IO₃⁻, AlCl₄⁻, BCl₄⁻, BrO₃⁻ anions can react with a lithium metal anode and form a halide, such as LiF, LiCl, LiF-related or LiCl-related interfacial layer on the metallic lithium anode.

For example, without limitations and without wishing to be bound by any theory, it was hypothesized that when alkali metal salt comprises bis(trifluoromethane)sulfonimide anion (TFSI⁻), the divalent (Mg²⁺, Ba²⁺, Sc²⁺, Zn²⁺, Sn²⁺), trivalent (Al³⁺, Y³⁺) cations can coordinate more TFSI⁻ anions with higher bond strength. In still further exemplary aspects, such coordination with the TFSI⁻ can lead to an increase in the concentration of mobile Li ions in the matrix. For example, Mg(ClO₄)₂, wherein Mg²⁺ has a similar radius size similar to that of the lithium ions, preferentially binds with oxygen from the polymer host and TFSI⁻ anions from LiTFSI ion-pairs.

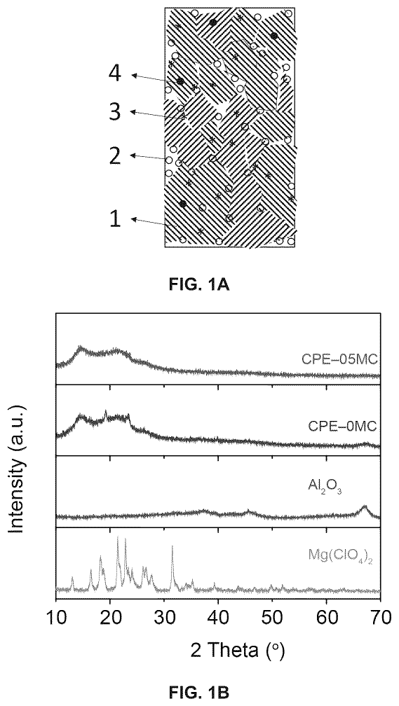

In still further aspects, and as disclosed above, the solid-state ion-conducting composite electrolyte as disclosed herein is substantially homogeneous. In still further aspects, the solid-state ion-conducting composite electrolyte, as disclosed herein, is substantially flexible. It is understood that the flexibility of the electrolyte provides additional benefits, such as better conformity to a surface of the electrode in the electrochemical cell, better wetting of the electrode surface, and the like. An exemplary schematic of the solid-state electrolyte of the current disclosure is shown in FIG. 1A. FIG. 1A depicts a polymer host (1), ceramic particles (2), alkali metal salt (3), and a functional additive substantially homogeneously dispersed throughout the solid-state electrolyte.

In still further aspects, when the disclosed herein solid-state ion-conducting composite electrolyte is used in an electrochemical cell, the cell can operate at a dendrite-free critical current density up to about 2 mA cm⁻², including exemplary values about 0.01 mA cm⁻², about 0.05 mA cm⁻², about 0.08 mA cm⁻², about 0.1 mA cm⁻², about 0.2 mA cm⁻², about 0.3 mA cm⁻², about 0.4 mA cm⁻², about 0.5 mA cm⁻², about 0.6 mA cm⁻², about 0.7 mA cm⁻², about 0.8 mA cm⁻², about 0.9 mA cm⁻², about 1 mA cm⁻², about 1.2 mA cm⁻², about 1.3 mA cm⁻², about 1.4 mA cm⁻², about 1.5 mA cm⁻², about 1.6 mA cm⁻², about 1.7 mA cm⁻², about 1.8 mA cm⁻², and about 1.9 mA cm⁻². In such aspects, the electrochemical cell comprising the disclosed herein electrolyte can withstand current densities that are up to about 2 times, up to about 3 times, up to about 4 times, up to about 5 times higher when compared to a substantially identical reference solid-state ion-conducting composite electrolyte in the absence of the functional additive. In still further aspects, the electrochemical cell comprising the disclosed herein electrolyte can withstand current densities that are at least about 2 times, at least about 3 times, at least about 4 times, at least about 5 times higher when compared to a substantially identical reference solid-state ion-conducting composite electrolyte in the absence of the functional additive.

In still further aspects, when the disclosed herein solid-state ion-conducting composite electrolyte is used in an electrochemical cell, the cell can operate provide an areal capacity up to about 0.5 mAh cm⁻², including exemplary values about 0.01 mAh cm⁻², about 0.05 mAh cm⁻², about 0.08 mAh cm⁻², about 0.1 mAh cm⁻², about 0.12 mAh cm⁻², about 0.15 mAh cm⁻², about 0.18 mAh cm⁻², about 0.2 mAh cm⁻², about 0.22 mAh cm⁻², about 0.25 mAh cm⁻², about 0.28 mAh cm⁻², about 0.3 mAh cm-2, about 0.32 mAh cm⁻², about 0.35 mAh cm⁻², about 0.38 mAh cm⁻², about 0.4 mAh cm⁻², about 0.42 mAh cm⁻², about 0.45 mAh cm⁻², and about 0.48 mAh cm⁻².

In still further aspects, the electrochemical cell comprising the disclosed herein solid-state ion-conducting composite electrolyte provides the areal capacity that is up to about 2 times, up to about 3 times, up to about 4 times, or even up to about 5 times higher than the areal capacity of a substantially identical reference solid-state ion-conducting composite electrolyte in the absence of the functional additive.

In still further aspects, the electrolyte is configured to operate in a temperature range from about 20° C. up to about 60° C., including exemplary values of about 25° C., about 30° C., about 35° C., about 40° C., about 45° C., about 50° C., and about 55° C.

In still further aspects, when the disclosed herein electrolyte is used in an electrochemical cell, the cell is capable of obtaining a high charge-discharge Coulombic efficiency of the cell greater than about 99.0%, greater than about 99.1%, greater than about 99.2%, greater than about 99.3%, greater than about 99.4%, greater than about 99.5%, greater than about 99.6%, greater than about 99.7%, greater than about 99.8%, or greater than about 99.9% for about 100 cycles.

In still further aspects, the solid-state ion-conducting electrolyte of the current disclosure can have a thickness of at least about 10 μm, at least about 25 μm, at least about 50 μm, at least about 75 μm, at least about 100 μm, at least about 125 μm, at least about 150 μm, at least about 200 μm, or at least about 250 μm. In still further aspects, the thickness can be between about 10 μm and about 250 μm, between about 25 μm and about 250 μm, between about 50 μm and about 250 μm, between about 75 μm and about 250 μm.

### Electrochemical Cell

Also disclosed herein is an electrochemical cell comprising: a) a metal anode comprising an electrochemically active surface; b) a solid-state ion-conducting composite electrolyte comprising: i) a polymer host; ii) an alkali metal salt comprising a monovalent metal cation, wherein the alkali metal salt is dispersed in the polymer host; and iii) a functional additive comprising at least about one divalent and/or trivalent metal cation; wherein an ionic radius of the at least about one divalent and/or trivalent metal cation of the functional additive is substantially similar to an ionic radius of the monovalent metal cation of the alkali metal salt; and wherein the functional additive is substantially dissolved within the polymer host; and wherein the solid-state ion-conducting composite electrolyte has an ionic conductivity of at least about 10⁻⁴ S/cm at room temperature; and wherein the solid-state ion-conducting composite electrolyte is flexible and is in electrical communication with the metal anode; and c) a solid-state electrolyte interphase layer formed in-situ and is disposed on the electrochemically active surface of the metal anode.

In still further aspects, the solid-state ion-conducting composite electrolyte comprises any of the disclosed above composite electrolytes compositions in any of the disclosed above concentrations and amounts.

In still further aspects, the metal anode can comprise Li, K, Na, or Cs, or combinations and alloys thereof. In yet still further aspects, the metal anode comprises Li.

In still further aspects, and as disclosed herein, a solid electrolyte interphase (SEI) layer can be formed in-situ during the electrochemical cell operation. This SEI layer can suppress the nucleation of lithium dendrites and increases the critical current density. In certain aspects, the SEI layer can comprise at least one of halide or fluoride, depending on the solid-state ion-conducting composite electrolyte composition.

In still further aspects, the SEI layer formed in the disclosed electrochemical cell can behave as an electronic insulator, exhibiting an electrochemical window as wide as from 0 to about 6.5 V vs. Li⁺/Li reference electrode for LiF, including exemplary values of t 0 to about 3.5 V vs. Li⁺/Li, about 0.2 to about 3.8 V vs. Li⁺/Li, about 0.7 to about 4.0 V vs. Li⁺/Li, about 2.0 to about 4.2 V vs. Li⁺/Li, about 2.75 to about 4.5 V vs. Li⁺/Li, and about 2.75 to about 5.7 V vs. Li⁺/Li. Yet, in other aspects, the electrochemical window can be from 0 to about 6.4 V about vs. Li⁺/Li reference electrode. In still further aspects, the electrochemical window can include any value between any two foregoing values.

In still further aspects, the SEI layer that is formed in-situ can have a thickness from about 10 nm to about 100 nm, including exemplary values of about 20 nm, about 30 nm, about 40 nm, about 50 nm, about 60 nm, about 70 nm, about 80 nm, and about 90 nm. It is understood, however, that the SEI can have any thickness that falls between any foregoing values.

In still further aspects, the SEI layer formed in the disclosed electrochemical cell can exhibit a low Li⁺ diffusion barrier energy from 0 to about 0.8 eV, including exemplary values of about 0.01 eV, about 0.05 eV, about 0.08 eV, about 0.1 eV, about 0.12 eV, about 0.15 eV, about 0.18 eV, about 0.2 eV, about 0.22 eV, about 0.25 eV, about 0.28 eV, about 0.3 eV, about 0.32 eV, about 0.35 eV, about 0.38 eV, about 0.4 eV, about 0.42 eV, about 0.45 eV, about 0.48 eV, about 0.5 eV, about 0.52 eV, about 0.55 eV, about 0.58 eV, about 0.6 eV, about 0.62 eV, about 0.65 eV, about 0.68 eV, about 0.7 eV, about 0.72 eV, about 0.75 eV, and about 0.78 eV.

In still further aspects, the SEI layer formed in the disclosed electrochemical cell can exhibit an ionic conductivity of about 106 to about 10⁻⁴ S cm⁻¹, including exemplary values of about 1×10⁻⁶ S cm⁻¹, about 2× 10⁻⁶ S cm⁻¹, about 3×10⁻⁶ S cm⁻¹, about 4×10⁻⁶ S cm⁻¹, about 5×10⁻⁶ S cm⁻¹, about 6×10⁻⁶ S cm⁻¹, about 7×10⁻⁶ S cm⁻¹, about 8×10⁻⁶ S cm⁻¹, about 9×10⁻⁶ S cm⁻¹, about 1×10⁻⁵ S cm⁻¹, about 2×10⁻⁵ S cm⁻¹, about 3×10⁻⁵ S cm⁻¹, about 4×10⁻⁵ S cm⁻¹, about 5×10⁻⁵ S cm⁻¹, about 6×10⁻⁵ S cm⁻¹ about 7×10⁻⁵ S cm⁻¹, about 8×10⁻⁵ S cm⁻¹, about 9×10⁻⁵ S cm⁻¹, and about 1×10⁻⁴ S cm⁻¹. It is understood, however, that the SEI disclosed herien can also exhibit conductivity higher than about 1×10⁻⁴ S cm⁻¹, for example it can be about 1.5×10⁻⁴ S cm⁻¹, about 2×10⁻⁴ S cm⁻¹, about 3×10⁻⁴ S cm⁻¹, about 4×10⁻⁴ S cm⁻¹, or about 5×10⁻⁴ S cm⁻¹.

The electrochemical cell of the present disclosure can further comprise a cathode. It is understood that any known in the art cathode materials that can be useful for the desired purpose can be utilized. In some aspects, the cathode can be a metal cathode or composite cathode. If the metal cathode is used, such an electrochemical cell can be a symmetrical electrochemical cell. In such an exemplary aspect, when the electrochemical cell is symmetrical, both anode and cathode comprise the same material, for example, and without limitation, it can comprise Li. In other words, there are some exemplary aspects, where the anode material of the electrochemical cell is Li and the cathode material used in the same cell is also Li.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In yet still further aspects, the cathode can comprise a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode. In yet still further aspects, the cathode material can also comprise a poly(ethylene oxide), cellulose, carboxymethylcellulose (CMC), a polytetrafluoroethylene (PTFE), styrene-butadiene rubber (SBR), or a polyvinylidene fluoride binder.

In still further aspects, the electrochemical cell as disclosed herein provides a critical current density of about 0.4 mA cm⁻² to about 2 mA cm⁻², including exemplary values of about 0.5 mA cm⁻², about 0.6 mA cm⁻², about 0.7 mA cm⁻², about 0.8 mA cm⁻², about 0.9 mA cm⁻², about 1.0 mA cm⁻², about 1.1 mA cm⁻², about 1.2 mA cm⁻², about 1.3 mA cm⁻², about 1.4 mA cm⁻², about 1.5 mA cm⁻², about 1.6 mA cm⁻², about 1.7 mA cm⁻², about 1.8 mA cm⁻², and about 1.9 mA cm⁻².

In still further aspects, the electrochemical cell as disclosed herein can provide a high areal capacity from about 0.1 mAh cm⁻² to about 0.5 mAh cm⁻², including exemplary values of about 0.11 mAh cm⁻², about 0.12 mAh cm⁻², about 0.13 mAh cm⁻², about 0.14 mAh cm⁻², about 0.15 mAh cm⁻², about 0.16 mAh cm⁻², about 0.17 mAh cm 2, about 0.18 mAh cm⁻², about 0.19 mAh cm⁻², about 0.2 mAh cm⁻², about 0.22 mAh cm⁻², about 0.23 mAh cm⁻², about 0.24 mAh cm⁻², about 0.25 mAh cm⁻², about 0.26 mAh cm⁻², about 0.27 mAh cm⁻², about 0.28 mAh cm⁻², about 0.29 mAh cm⁻², about 0.3 mAh cm⁻², about 0.32 mAh cm⁻², about 0.33 mAh cm⁻², about 0.34 mAh cm⁻², about 0.35 mAh cm⁻², about 0.36 mAh cm⁻², about 0.37 mAh cm⁻², about 0.38 mAh cm⁻², about 0.39 mAh cm⁻², about 0.4 mAh cm⁻², about 0.42 mAh cm⁻², about 0.43 mAh cm⁻², about 0.44 mAh cm⁻², about 0.45 mAh cm⁻², about 0.46 mAh cm⁻², about 0.47 mAh cm⁻², about 0.48 mAh cm⁻², and about 0.49 mAh cm⁻².

In still further aspects, the electrochemical cell, as disclosed herein, is capable of providing a substantially stable plating at about 0.1 mA cm⁻² for up to about 10 up to about 15 h, up to about 20 h, up to about 25 h, up to about 30 h, up to about 35 h.

In still further aspects, the electrochemical cell can exhibit a cyclic Coulombic efficiency greater than about 99.1% for about 100 cycles, including In still further aspects, when the disclosed herein electrolyte is used in an electrochemical cell, the cell is capable of obtaining a high charge-discharge Coulombic efficiency of the cell greater than about 99.0%, greater than about 99.1%, greater than about 99.2%, greater than about 99.3%, greater than about 99.4%, greater than about 99.5%, greater than about 99.6%, greater than about 99.7%, greater than about 99.8%, or greater than about 99.9% for about 100 cycles.

In yet still further aspects, the cell can exhibit a substantial discharge capacity retention greater than about 70%, greater than about 75%, greater than about 80%, greater than about 85%, greater than about 90%, greater than about 95%, greater than about 99% after about 100 stripping/plating cycles. In yet still further aspects, the cell can exhibit a substantial discharge capacity retention of no less than about 99.9%, no less than about 99%, no less than about 95%, no less than about 90%, no less than about 85%, no less than about 80%, no less than about 75%, or no less than about 70% after about 100 stripping/plating cycles

In still further aspects, the electrochemical cell is configured to operate in a temperature range from about 20° C. up to about 60° C., including exemplary values of about 25° C., about 30° C., about 35° C., about 40° C., about 45° C., about 50° C., and about 55° C. It is understood that a time window for the cell operation can be dependent on the operating conditions, such as operating current density and areal capacity. For example, at low current densities and the areal capacities, the dendritic lithium growth kinetic is slow so that the electrochemical cell can operate for a prolonged time. In some exemplary and unlimiting aspects, when the cell operates at the areal capacity is 0.1 mAh cm⁻² and a current density of as high as 1.2 mA cm⁻², the symmetric electrochemical cell can operate for about 30 hours, about 50 hours, about 100 hours. If the areal capacity is as high as 0.5 mAh cm⁻² and a current density of 0.4 mA cm⁻² is applied, the symmetric cell operates for 30 hours, about 50 hours, or about 80 hours. It is understood that an increase in the areal capacity and the current density can decrease the lifespan of the electrochemical cell.

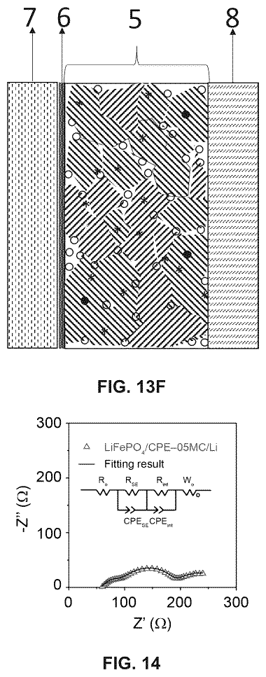

In still further aspects, the electrochemical cell, as disclosed herein, is a battery. In yet other aspects, the battery is a rechargeable battery. An exemplary schematic of the battery is shown in FIG. 13F where 5—depicts a solid-state electrolyte; 6—an SIE layer, 7—a lithium anode, and 8—a composite electrode, such as LiNi_{0.8}Co_{0.1}Mn_{0.1}O₂, for example.

By way of example, electrochemical cells of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series.

### Methods

Further disclosed herein are methods comprising: a) forming a mixture of a polymer host, an alkali metal salt, and a functional additive in a solvent, wherein the alkali metal salt comprises a monovalent cation; wherein the functional additive comprises at least about one divalent and/or trivalent metal cation and wherein an ionic radius of the metal cation of the functional additive is substantially similar to an ionic radius of the monovalent metal cation of the alkali metal salt, and b) removing the solvent to form a flexible solid-state ion composite conducting electrolyte comprising the alkali metal salt and the functional additive that is substantially dispersed within the polymer host; wherein the flexible solid-state ion-conducting composite electrolyte has an ionic conductivity of at least about 10⁻⁴ S/cm at room temperature.

It is understood that any known in the art solvents applicable to this specific application can be used. In some aspects, the solvents can comprise acetonitrile (ACN), N-Methyl-2-pyrrolidone (NMP), dimethylformamide (DMF), tetrahydrofuran (THF), or any combination thereof. The disclosed methods form any of the described above solid-state ion-conducting electrolytes.

Also disclosed are methods of forming a battery comprising disposing any of the solid-state ion-conducting composite electrolytes disclosed herein between an electrochemically active surface of a metal anode and a cathode.

By way of non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Materials

Commercially available chemicals were purchased. The poly(ethylene oxide) (PEO, M_{w}=600,000 g mol⁻¹), lithium bis(trifluoromethanesulfonyl)imide (LiTFSI, 98%, TCI), Mg(ClO₄)₂ (purity 99%, Sigma-Aldrich), and Al₂O₃ powder (Sigma-Aldrich, 5.8 nm) were dried before use.

### Fabrication of PEO-Based Composite Electrolyte

The PEO-based composite electrolyte was prepared by a solution casting technique using anhydrous acetonitrile (ACN) as a solvent. Initially, PEO and LiTFSI (EO:Li=10:1) were thoroughly dissolved in acetonitrile under continuous stirring at 55° C., a mixture of Al²O₃ and Mg(ClO₄)₂ was added to the above solution. The weight ratio of the Al²O₃ nanofiller was fixed at 15 wt %. The resulting gelatinous solution was stirred at 55° C. for 12 h and then poured onto a polytetrafluoroethylene (PTFE) plate, followed by drying under a vacuum for 12 h.

Assembly of all-Solid-State Cells

Symmetric cells were assembled in 2032 coin cells by sandwiching the polymer membrane between two stainless steel (SS) discs or two lithium foil or magnesium belt electrodes. The surface of lithium foil and magnesium belt with an areal of 0.5 cm⁻² were scratched with a scalpel before use. The areal of the stainless steel disc is 1.6 cm⁻².

The LiFePO₄ cathode was prepared as described elsewhere by mixing LiFePO₄, carbon, PEO, and LiTFSI salt in acetonitrile with a weight ratio of 60:10:20:10. The slurry was coated on the carbon-coated aluminum foil by a doctor blade and then dried at 60° C. under vacuum. Here, the loading of the LiFePO₄ active material is 5 mg cm⁻². For the LiNi_{0.8}Mn_{0.1}Co_{0.1}O₂ (NMC) composite cathode, NMC particles, carbon, polyvinylidene fluoride (PVDF), and LiTFSI salt with a weight ratio of 70:10:13:7 were mixed in dimethylformamide (DMF). The loading of the NMC active material is 3 mg cm⁻².

### Characterization

X-ray Diffraction results of the polymers were determined by an X-ray diffractometer (Rigaku MiniFlex 600) with a step of 0.02° from 10 to 70°. For Fourier transform infrared (FTIR) transmittance spectroscopy, composite electrolytes were pressed on Ge diamond in a sealable capsule and transferred from the glovebox to the FTIR instrument (Thermo Mattson, Infinity Gold FTIR). FTIR data were collected at room temperature from 400 to 3000 cm⁻¹ (4 cm⁻¹ resolution). 256 times spectra were acquired for an acceptable signal-to-noise level. Peakfit software was used to fit the spectra with the pseudo-Voigt functions, in which the Lorentzian/Gaussian characters and full width at half-maximum (FWHM) could be varied manually. 6Li solid-state MAS (4 kHz) spectra were recorded on a Bruker AV400 spectrometer with a 4 mm probe (one-pulse sequence). ⁶Li chemical shift is calibrated relative to Li₂CO₃ at 0 ppm. The morphologies of samples were examined by scanning electron microscopy (SEM, FEI QUANTA 650).

The Li⁺ ionic conductivity measurements of the composite electrolytes were carried out on an electrochemical station (Auto Lab workstation) with stainless steel (SS) as the electrode. The measurements were performed over the frequency range from 1 Hz to 1 MHz with an AC voltage amplitude of 10 mV. SS/CPE-xMC/SS cells were thermally equilibrated in the thermostat for at least about 1 h at each temperature prior to measurement. The cation ions transference number (t_{Li}⁺, t_{Mg}²⁺) of the polymer electrolytes were obtained by AC impedance and DC polarization measurements using symmetric Li//Li and Mg//Mg cells. The symmetric cells were aged at 55° C. for 2 h for obtaining good contact and a stable interface between the electrolytes and electrodes. A DC voltage of 10 mV was applied until a steady current was achieved (nearly 6000 s).

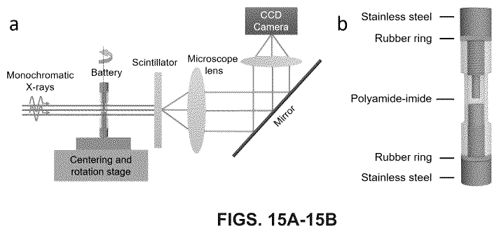

The cells were imaged using the non-destructive synchrotron X-ray tomography technique conducted at the tomography station at BAMline end station at BESSY II, Helmholtz-Zentrum Berlin, Germany, which makes it possible to directly visualize the electrodes three-dimensionally (FIGS. 15A-15B). Monochromatic hard X-rays with an energy of 20 keV (ΔE/E=1.5%) were directed onto the sample. The transmitted X-rays were converted into visible light using a scintillator (CdWO₄, 60 μm in thickness), which were then magnified by a set of microscope optics before being projected on a CCD sensor (PCO4000 camera, 4008×2672 pixel). A (4.4×2.9) mm² field of view was used with a pixel size of 1.095 μm. During a rotation of 180°. 2200 projections and 230 flatfields with an exposure time of 1.6 s for each projection/flatfield were collected. 3D image reconstruction follows the same procedure as in Dong, K. et al., Nano Energy 62, 11-19 (2019). Image segmentation was conducted using Image J/Weka followed by the visualization using VGSTUDIO MAX 3.1 (Schindelin, J. et al., Nat. Methods 9, 676-82 (2012)). All the symmetrical Li/polymer/Li cells are galvanostaticly discharged (stripping) and charged (plating) using a Neware BTS400 multichannel battery testing system. After cycling, the cells were transferred to the beamline to conduct tomography without cell disassembly.

X-ray photoelectron spectroscopy (XPS, Kratos AXIS Ultra DLD spectrometer) was acquired by using an Al K_{α} (λ=0.83 nm, hv=1,486.7 eV) X-ray source operated at 2 KV and 20 mA. The C 1s main peak at 284.6 eV was used as the reference to calibrate peak shifts caused by surface-charging effects. Time-of-flight secondary ion mass spectrometry (TOF-SIMS) was employed to study the surface composition of the membranes and the Li anode. For depth profiling, a Bi⁺ ion beam (30 keV ion energy, ˜4 pA measured sample current) was used to analyze 100×100 μm² areas, while a Cs⁺ ion beam (500 eV ion energy, ˜40 nA measured sample current) was used to sputter 300×300 μm² areas centered around the analyzed areas. All depth profiles were acquired in noninterlaced mode, that is, sequential sputtering and analysis.

### Molecular Dynamic Calculations

Molecular dynamic calculations were performed using Large-scale Atomic/Molecular Massive Parallel Simulator (LAMMPS) (Plimpton, S., Comput. Phys. 117, 1-19 (1995)). The interactions between atoms are described using Lennard-Jones potential obtained from Kubisiak, P. et al., J. Phys. Chem. C 122, 12615-12622 (2018). The simulated system contains 1000 oxygen from PEO chains (Mw=600 k) and 400 oxygen from LiTFSI with 1 Mg(ClO₄)₂. All ions and molecules were packed into a periodic simulation box using Packmol code (Martinez, L. et al., J. Comput. Chem. 30, 2157-64 (2009)). The structure was initially optimized using the conjugate gradient method for 5000 steps and then heated to 600 K in NVE dynamics with a Langevin thermostat during 1×10⁵ ps. At last, the system was simulated at 600 K for 400 ns in an NPT ensemble using Nose/Hoover temperature thermostat and Nose/Hoover pressure barostat. Diffusion coefficients of Li⁺, Mg²⁺, and TFSI⁻ ions were calculated based on mean-squared displacement (MSD).

### Density Functional Theory

Calculations Density functional theory (DFT) calculations were performed with the projector augmented wave method, as implemented in the Vienna ab initio simulation (VASP) package (Blochl, P. E. Phys. Rev. B Condens. Matter. 50, 17953-17979 (1994); Kresse, G. et al., Phys. Rev. B 59, 1758-1775 (1991); Kresse, G. et al., Phys. Rev. B Condens. Matter. 49, 14251-14269 (1994); Kresse, G. et al., Physical Review B 54, 11169-11186 (1996)).

A supercell including sixteen Li₂MgCl₄ unit cells was optimized using a 4×4×4 k-points mesh, a plane-wave cutoff of 450 eV, and force convergence of 2.5 meV Å⁻¹. To investigate the ionic conductivity transport process in Li₂MgCl₄, lithium ionic diffusion through the vacancy mechanism in Li_{31/16}MgCl₄ was simulated through Climbing Image NEB (cNEB) method (Mathew, K. et al., J. Chem. Phys. 140, 084106 (2014)). The migration path and diffusion energy barriers are obtained.

### Results and Discussion

### Li⁺ Conductivity and Transport Mechanism

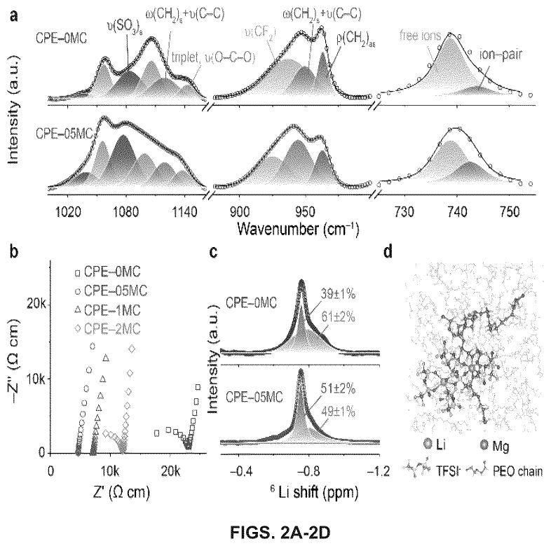

Owing to the low degree of dissociation of Mg(ClO₄)₂ in PEO at room temperature, a concentration of less than 2 wt % Mg(ClO₄)₂ was solvated in the composite polymer electrolytes (CPEs) for testing. (Kumar, Y. et al., Electrochimica Acta 56, 3864-3873 (2011)). As LiTFSI and Mg(ClO₄)₂ completely dissolved into the PEO host, no clear diffraction peaks of crystalline LiTFSI, Mg(ClO₄)₂, and PEO were observed (FIG. 1), indicating the amorphous nature of the polymer. To understand the chemical interactions between the polymer host and the ions, the coordination environment of the functional groups in the PEO-based electrolytes was monitored by Fourier-transform infrared spectroscopy (FTIR). The deconvoluted FTIR spectra in FIG. 2A shows four vibrational modes of (O—C—O), (CH₂), (SO₃), (CF₂), and (S—N) in the frequency range of 1160-1000 cm⁻¹, 1000-880 cm⁻¹, and 750-720 cm⁻¹, respectively.

The characteristic peak of ClO₄⁻ at 620 cm⁻¹ cannot be observed because of the low concentration of Mg(ClO₄)₂. The vibrational peaks at 1060, 1106, and 1140 cm⁻¹ are assigned to the triplet C—O—C stretching, while the peaks at 945 and 1120 cm⁻¹ are from combined CH₂ and C—C stretching. A band associated with the mixed symmetric and antisymmetric longitudinal modes of CH₂ (wagging and twisting, respectively) is attributed to the peak at 963 cm⁻¹. The peak shapes related to the C—O—C vibration change dramatically from the base CPE (CPE-0MC) to the CPE with 0.5 wt % Mg(ClO₄)₂ (CPE-05MC); the CH₂ vibration peak shifts to lower wavenumbers.

Without wishing to be bound by any theory, it was suggested that these observations demonstrate the distorted and stretched PEO conformation resulting from an intensive interaction between the Mg²⁺-cations and the ether groups, which influences the electron energy level of PEO segments and improves the electrochemical stability of the PEO-based polymer electrolyte.

Again, without wishing to be bound by any theory, it was assumed that the peaks at 1078, 1032, and 933 cm⁻¹ are due to asymmetric and symmetric SO₃ stretching and CF₂ rocking modes within the TFSI⁻ anions, respectively. The red-shift of these peaks in the CPE-05MC membrane can reveal a significant intermolecular interaction between TFSI⁻ and Mg²⁺ ions.

Without wishing to be bound by any theory, a decrease in the integral intensity of the peak at about 740 cm⁻¹, corresponding to S—N stretching of the “free” imide bands, was assumed to indicate that more TFSI⁻ anions exist as ion pairs (e.g., Li⁺/Mg²⁺—TFSI⁻) in the CPE-05MC membrane.

The influence of the Mg(ClO₄)₂ concentration on the PEO conductivity was investigated by electrochemical impedance spectroscopy (EIS). FIG. 2B shows the EIS spectra at 35° C. of CPEs with varying amounts of Mg(ClO₄)₂ additive (labeled xMC, x=0, 0.5, 1, and 2 wt %). Each PEO-based CPE used LiTFSI as the primary conducting salt with an EO: Li ratio of 10:1. A maximum conductivity of 2.15×10⁻⁴ S cm⁻¹ was observed for x=0.5 wt %, which is much higher than the baseline sample without Mg(ClO₄)₂ (4.31×10⁻⁵ S cm⁻¹).

In some exemplary and unlimiting aspects, the concentrations beyond 0.5 wt % of Mg(ClO₄)₂ may result in a possible decrease in the Li⁺ conductivity. Without wishing to be bound by any theory, it was assumed that the mobility of Li⁺ ions in the CPEs can possibly be reduced beyond a certain Mg(ClO₄)₂ concentration. It was hypothesized that a possible decrease in Li-ion mobility may be related to the formation of Li⁺—ClO₄⁻ pairs with a low degree of dissociation in the polymer host.

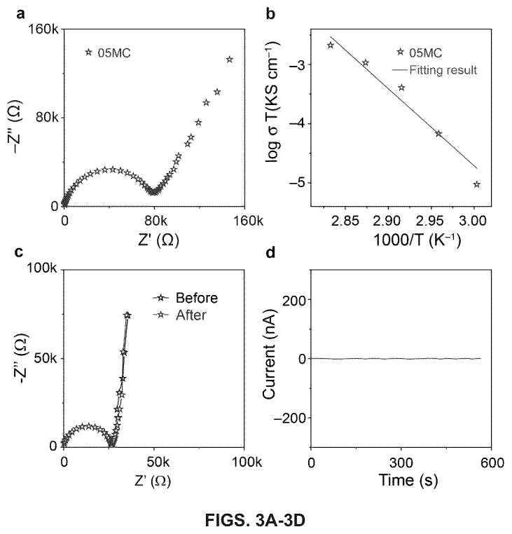

To determine the mobility of the Mg²⁺ ions in the PEO host, a CPE membrane with only Mg(ClO₄)₂ was prepared as a baseline for comparison to assess the contribution of Mg²⁺ ions to the total ionic conductivity in the other electrolytes that also had LiTFSI. FIGS. 3A-3D summarize the electrochemical data of the PEO sample with only Mg(ClO₄)₂.

Previously, it was found that the PEO-based polymer electrolytes with magnesium salts offer an ionic conductivity ranging from 10⁻⁶ to 10⁻³ S cm⁻¹ at 30˜100° C. The Mg²⁺-ion conductivity mostly depends on the dissociation of magnesium salts in the polymer host and the liquid-forming component in the complex. Mg²⁺ ions in the cross-linked polymer electrolyte containing Mg[(CF₃SO₃)₂N]₂ and dimethyl formamide reported an Mg²⁺ ionic conductivity around 10⁻⁴ S cm⁻¹ at room temperature. Here, it was assumed that given a strong electrostatic interaction between Mg²⁺ cations and ClO₄⁻ anions, the low dissolution of Mg(ClO₄)₂ in PEO, and the strong electrostatic interaction between the Mg²⁺ ion and the ether oxygen, would substantially restrict the mobility of Mg²⁺ ions in the PEO polymer. In this example, it was found that the electrolyte had an ionic conductivity of 1.6×10⁻⁷ S cm⁻¹ at 60° C. with an activation energy of 2.5 eV. Potentiostatic polarization of an Mg/Mg(ClO₄)₂-PEO/Mg cell showed an Mg²⁺ transference number of 0, indicating that the ionic conductivity predominately stems from anion migration.

Room temperature ⁶Li solid-state MAS (4 kHz) nuclear magnetic resonance (NMR) spectroscopy probed the Li⁺ environments in the CPE-0MC and CPE-05MC, and the results are shown in FIG. 2C. The Gaussian peak at −0.82 ppm is ascribed to less mobile Li⁺ ions that are coordinated to EO and TFSI⁻; the Lorentzian peak at −0.75 ppm is attributed to more mobile Li⁺ ions in the CPEs with lower coordination.

A 12% increase in the ⁶Li peak at −0.75 ppm is observed in the CPE-05MC over the CPE-0MC. Thus, without wishing to be bound by any theory, it was assumed that the introduction of Mg²⁺ ions into the CPE enhances the population of mobile Li⁺ carriers in the CPE-05MC electrolyte compared to the baseline CPE without Mg(ClO₄)₂.

Molecular dynamics (MD) simulations were further performed to elucidate the subtle interactions of Mg²⁺ ions with the PEO host and confirm the hypothesis of greater availability of mobile lithium in the CPE with proper Mg(ClO₄)₂ additive. The atomic position and the trajectory of the ions were convoluted owing to the thermal effect; thus, deconvolution of the ionic trajectories was necessary to clearly show the ion interactions. FIG. 2D shows a snapshot from the calculations that demonstrate the coordination of Li⁺ is disrupted by the more ionic Mg²⁺, which tends to coordinate with 3 oxygen atoms from EO and 3 oxygen atoms from TFSI⁻.

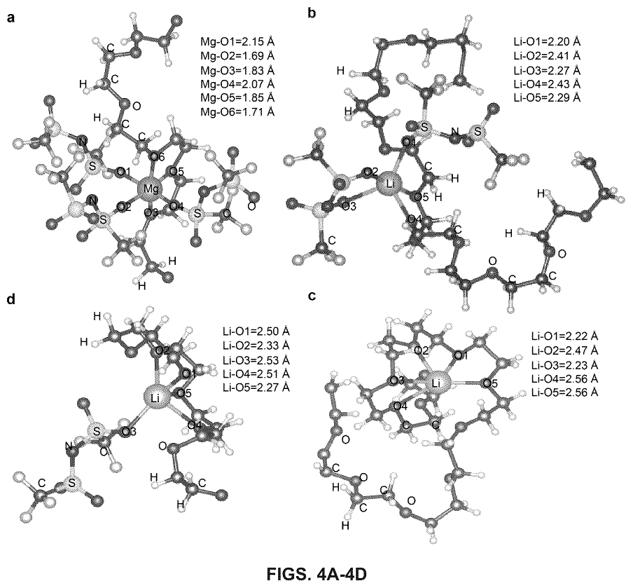

Without wishing to be bound by any theory, it was hypothesized that as the interaction strength of nearby Li⁺ ions becomes weaker, the local diffusion of Li⁺ ions along the PEO segments is enhanced. To investigate the local coordination structure, the radial distribution function of M-O bonds (M=Li⁺ or Mg²⁺) in four representative systems were simulated. FIGS. 4A-4D show that the average bond distances between Mg²⁺ and TFSI⁻ (1.88 Å) as well as between Mg²⁺ and EO (1.89 Å) are shorter than the corresponding bond distances for Li⁺, which were 2.33 Å and 2.25 Å for TFSI⁻ and EO, respectively.

Again, without wishing to be bound by any theory, it was assumed that the strong ionic Mg²⁺-TFSI⁻ bond can reduce the bond strength of Li⁺-TFSI⁻ and release more Li⁺ ions for ionic transport in CPE. During the diffusion process, the coordination competition of Li⁺ and Mg²⁺ ions with oxygen can serve as the trigger for high Li⁺ mobility and reconfiguration of surrounding Li⁺ ions to accommodate the constraints from ether group/TFSI⁻ anions, and thus improving Li⁺ migration through the CPE-05MC.

An MD simulation at 600 K provided the Li⁺ diffusion coefficient in the CPEs with and without the Mg²⁺ additive, which was 1.38×10⁻⁶ and 1.16×10⁻⁶ cm⁻² sec⁻¹ respectively. This result validates the observation of increased Li⁺ mobility in the CPE-xMC (x>0) electrolytes over the CPE-0MC electrolyte. Moreover, a diffusion coefficient on the order of ˜10⁻²⁹ cm² sec⁻¹ was calculated for Mg²⁺ in each material, which is many orders of magnitude below that of Li⁺ that supports the experimental findings that Mg²⁺ is not mobile in these electrolytes.

### Li/Li Symmetric Cell Performance

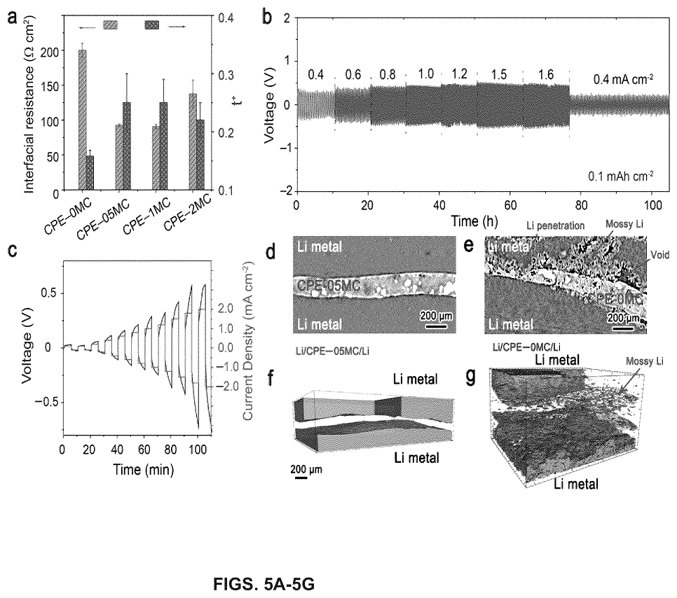

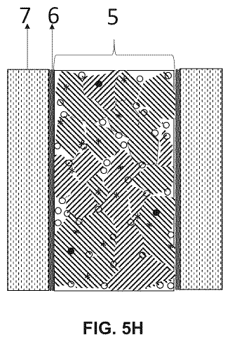

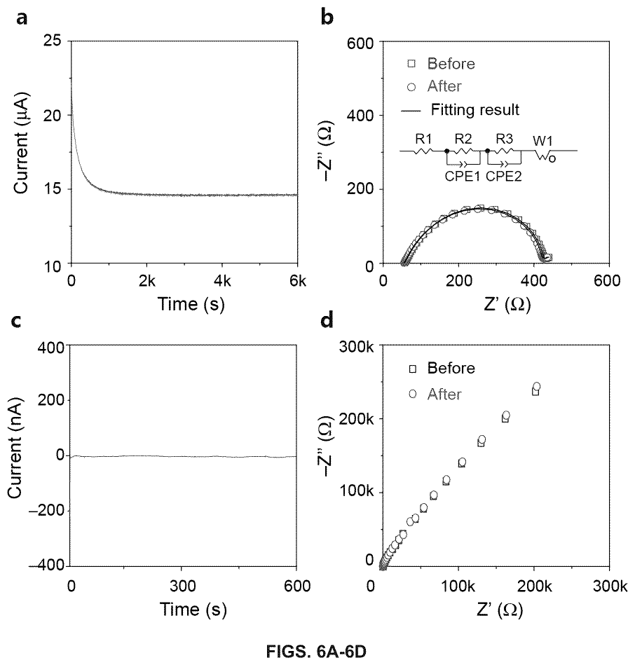

Symmetric Li/Li cells with the CPE-xMC electrolytes were assembled to study the influence of the Mg(ClO₄)₂ additive on the Li/CPE-xMC interface. The interfacial resistance of the Li/Li symmetric cells is summarized in FIG. 5A. The symmetric cell with CPE-05MC showed the smallest interfacial resistance of 92.5 Ωcm⁻², which is half the value measured for the cell with CPE-0MC. Moreover, the CPE-05MC membrane had a higher average Li⁺-transference number (t_{Li}⁺=0.27) than that of CPE-0MC (t_{Li}⁺=0.15); there was no change in the interfacial resistance of the Li/CPE-05MC/Li cell before and after DC polarization (FIGS. 6A-6B)).

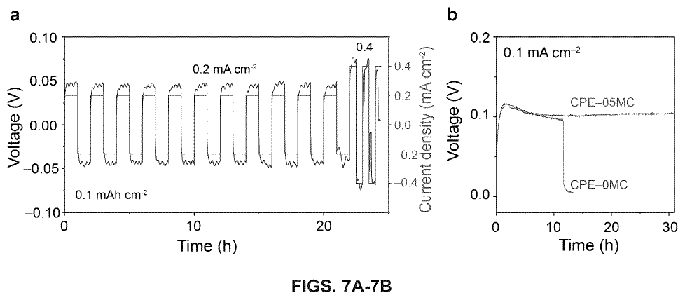

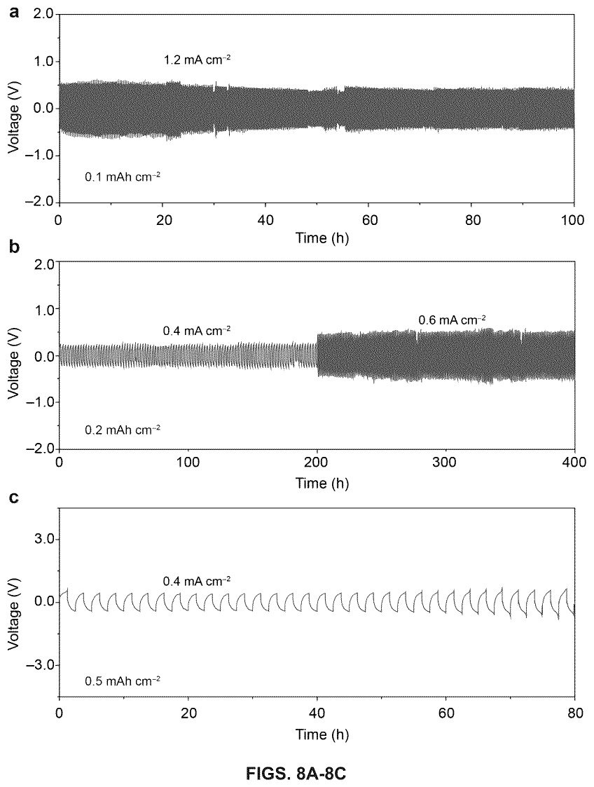

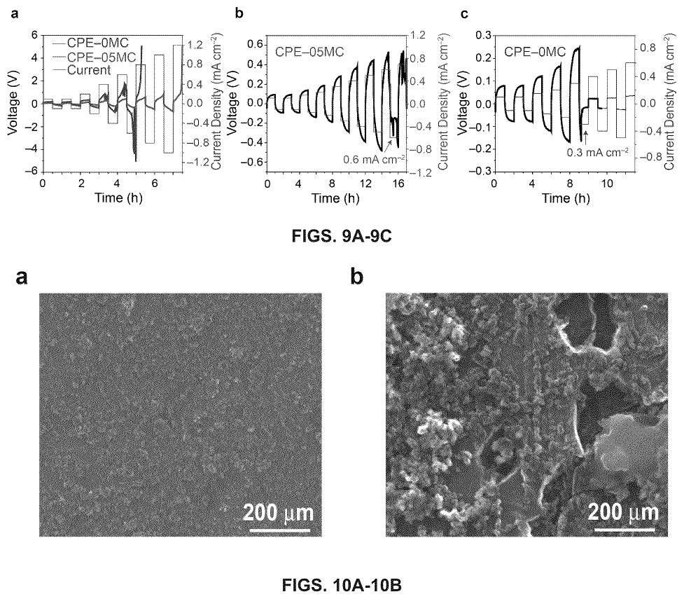

Symmetric cells with the CPE-05MC membranes having capacities of 0.1, 0.2, and 0.5 mAh cm⁻² were assembled for galvanostatic cycling experiments. FIGS. 5B-5C, and FIGS. 7-9 show long-term and variable-rate cycling data for Li/Li symmetric cells with the CPE-05MC electrolyte. The cycling curves in FIG. 5B of the Li/CPE-05MC/Li symmetric cell do not show any evidence of short-circuiting due to dendrite penetration for current densities up to 1.6 mA cm⁻², where 0.1 mAh cm⁻² capacity of lithium metal was plated/stripped during each cycle. Symmetric cells with CPE-0MC short-circuited at 0.4 mA cm⁻² (FIG. 7A), indicating the ease with which lithium dendrites nucleate and grow through the CPE-0MC electrolyte even at a low plating capacity of 0.1 mAh cm⁻². The effect of LiClO₄ doped CPE was also examined, and no significant effect on the performance of lithium plating/stripping was observed. However, there was a significant difference in the cycling profiles of the Li/Li symmetric cells at 0.1 mA cm⁻² for the CPE-0MC and CPE-05MC electrolytes (FIG. 7B). The Li/CPE-05MC/Li symmetric cell showed a stable charging voltage curve up to 30 h at 0.1 mA cm⁻², corresponding to 15 μm thick (3 mAh) plated lithium electrodes. On the other hand, a Li/CPE-0MC/Li symmetric cell shorted after 11 h at 0.1 mA cm⁻² due to lithium dendrite permeation through the electrolyte. The Li/CPE-05MC/Li symmetric cell also showed stable cycling at a current density of 0.4 mA cm⁻² and a capacity of 0.5 mAh cm⁻² (FIGS. 8A-8C). To evaluate the critical current density of the 0.5 wt % Mg(ClO₄)₂ doped CPE, a rate performance test with a Li/Li symmetric cell was performed at current densities ranging from 0.05 to 2 mA cm⁻², the results of which are given in FIG. 5C and FIGS. 9A-9C.

For the baseline CPE-0MC, lithium dendrites formed at 0.4 mA cm⁻²; the greater polarization observed for the CPE-0MC sample can be attributed to its lower ionic conductivity, smaller lithium transference number and larger interfacial resistance than the CPE-05MC sample.

### Lithium Metal Dendrite Suppression

Ex-situ analysis of the lithium metal electrodes post-symmetric cell cycling was used to understand the improved performance of the CPE-05MC electrolyte and ensure its ability to suppress dendrite growth. Scanning electron microscopy (SEM) and non-destructive synchrotron X-ray tomography were used to probe the morphology of the lithium surface after symmetric cell cycling. Two cells with a total electrode/electrolyte interfacial contact area of 0.5 cm⁻² and an areal capacity of 0.1 mAh cm⁻² were cycled for ex-situ analysis of their lithium electrodes; one with the 0.5 wt % Mg(ClO₄)₂ additive and a control cell without additive. The symmetric Li/CPE-05MC/Li cell was stopped after the 10th discharge cycle, while the Li/CPE-0MC/Li cell cycled for analysis short-circuited after the 10 cycles. The lithium metal from the Li/CPE-05MC/Li cell (FIG. 5D and FIG. 10A) showed a uniform surface and maintained good contact with the polymer electrolyte after repeated plating/stripping during cycling. No lithium dendrite nucleation was observed, suggesting a uniform plating/stripping of lithium metal at the Li/CPE-05MC interface. In contrast, a mossy lithium morphology with voids was observed in the Li/CPE-0MC/Li cell (FIG. 5E and FIG. 10B). The dendritic fibrils from this sample have two parts, with some dendrites growing at the Li/CPE-0MC interface and others forming within the CPE-0MC itself. Dendrites gradually penetrated the CPE-0MC electrolyte until it ruptured, no longer serving as a continuous medium that could separate the two lithium electrodes. 3D reconstructed tomograms of the symmetric cells from the two samples provide further insight into the morphological evolution of the lithium metal electrodes after cycling. FIG. 5F shows the 3D tomogram of the cycled Li/CPE-05MC/Li cell where the gold volume elements represent the cycled lithium electrodes; no dendrite growth or formation of mossy lithium is observed on either side. However, the 3D tomogram of the Li/CPE-0MC/Li cell in FIG. 5G shows dendritic lithium growth as well as void formation in the lithium electrodes. These results confirm the strong influence of the Mg(ClO₄)₂ additive in suppressing lithium dendrite formation and growth when used in a PEO-based electrolyte against a lithium metal anode.

### Characterization and Chemical Stability of the Li/Composite Polymer Electrolyte Interface

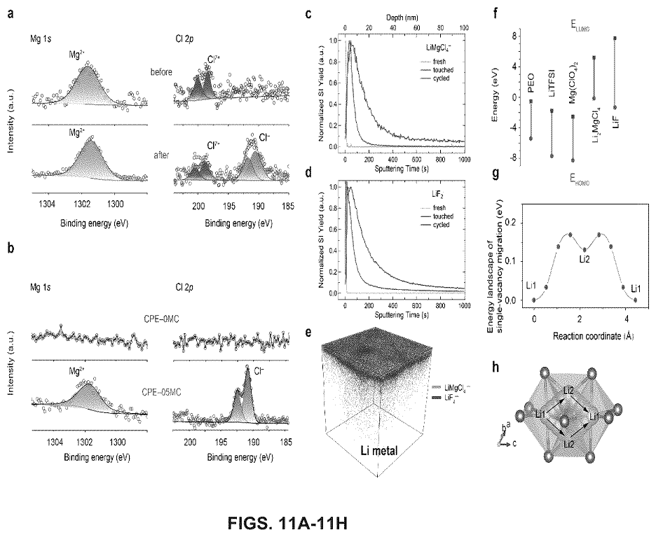

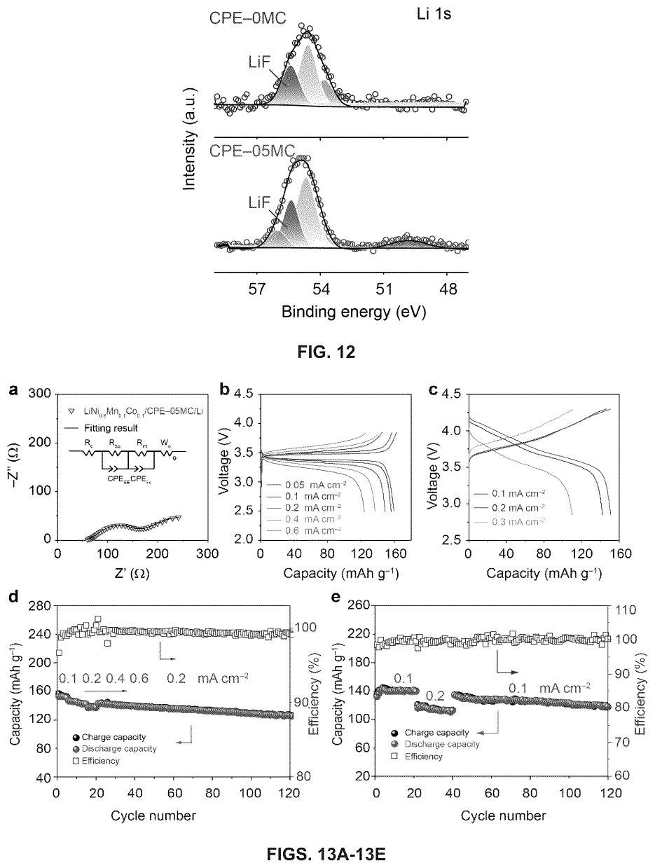

Further characterization of the Li/CPE-05MC/Li interface was necessary to understand the root cause of its superior performance in the Li/Li symmetric cells. X-ray photoelectron spectroscopy (XPS) and time-of-flight secondary ion mass spectrometry (TOF-SIMS) were employed to explore the chemical nature of the Li/CPE-05MC interface after symmetric cell cycling. FIGS. 11A-11B compared the XPS spectra of the CPEs and the lithium metal cycled in the symmetric cells, respectively. The peak at 1303 eV in the Mg 1s core level spectrum is assigned to an Mg²⁺ compound and remains constant on the electrolyte surface before and after cycling. A new peak appeared at 199.8 eV in the Cl 2p core-level spectrum of the CPE-05MC electrolyte after cycling, indicating the partial reduction of CI from the +7 to −1 valence state. This result implies the formation of a LiCl-related compound at the interface, presumably from the decomposition of the ClO₄⁻ anion in the Mg(ClO₄)₂ additive, which is in agreement with the 56.5 eV peak present in the Li 1s core level spectrum of the lithium metal after cycling (FIG. 12). The Li 1s core level spectrum shown in FIG. 12 also reveals a deconvoluted peak at 56.0 eV, which is indicative of LiF, owing to the reaction of the —SO₂F group in LiTFSI with the Li metal.

FIG. 11B shows the XPS spectra of the Li metal in contact with the CPE-0MC and CPE-05MC membranes during symmetric cell experiments. Although the CI 2p spectra of CPE-05MC showed ClO₄⁻ related peaks, there was no evidence of these species in the spectra taken on the lithium metal surface. This result indicates that a unique Cl⁻-involved interphase was formed at the Li/CPE-05MC interface. TOF-SIMS top-down depth profiles and their corresponding 3D renderings are shown in FIGS. 11C-11E. These experiments elucidated the SEI composition and helped quantify the SEI formed on the lithium metal surface. LiMgCl₄⁻ and LiF₂⁻ were chosen as representative species for Li₂MgCl₄ and LiF, respectively; the intensity of these two fragments in the TOF-SIMS spectra indicated them to be two primary components of the SEI on the lithium metal surface. As shown in FIG. 11C, the LiMgCl₄⁻ signal intensity remained high over the first 400 s of Cs⁺ sputtering, then quickly declined, which is characteristic of a species only present on the surface of the sample and not in bulk. This type of profile is to be expected for a lithium metal SEI layer that only forms a critical thickness during cycling. In this case, the thickness of the Li₂MgCl₄ layer was estimated to be 40 nm.

FIG. 11E shows the 3D rendering of the depth profiles presented in FIG. 11C-11D. A sharp visual contrast between the representative species in the interphase layer and the lithium metal demonstrates that the SEI fully covers the lithium metal and has a uniform thickness across the lithium metal surface. With the Mg(ClO₄)₂ additive, LiF is the dominant inorganic ingredient of SEI, generated at the electrolyte/Li metal interface for lithium protection. The short circuit of the symmetric Li/CPE-0MC/Li cell cycled at 0.4 mA cm⁻² confirmed that only LiF with high interfacial energy formed at the Li/CPE-0MC interface could not suppress lithium dendrite formation.

From these findings, it was concluded that the Li₂MgCl₄/LiF interlayer formed at the Li/CPE-05MC interface of the symmetric Li/CPE-05MC/Li cell plays two critical roles in suppressing the nucleation and growth of dendrites from the lithium metal: (1) Li₂MgCl₄ and LiF are good electronic insulators, each with a large electrochemical window, which restrains electrolyte decomposition and dendrites formation; (2) Li₂MgCl₄ and LiF provide a low Li⁺ diffusion barrier energy (0.17 eV of Li₂MgCl₄ and 0.73 eV of LiF, respectively), which facilitates Li⁺-transfer across the interface and promotes a uniform deposition of lithium metal. Each of these properties assists in the ability of this unique SEI to suppress lithium dendrite formation.

To verify the feasibility of the inferred chemical composition of the CPE-05MC/Li interface, density functional theory (DFT) calculations were used to confirm the feasibility of the experimental findings. PEO-LiTFSI electrolytes are known to form an SEI against lithium metal stemming from the reactivity of the TFSI⁻ anion. The orbital energy levels of the CPE-05MC base components and the experimentally determined reaction products determined from DFT are shown in FIG. 11F. Li₂MgCl₄ was calculated to have a LUMO of 5.2 eV at the interface, which is much higher than the LUMO calculated for any of the base components of the CPE-05MC electrolyte. Thus, the formation of this compound within the SEI increases the stability of the CPE-05MC against Li metal once formed.

Li₂MgCl₄ is a known solid-state electrolyte material with a wide bandgap; however, it has not been extensively studied since the 1980s. Thus, confirmation of the low-energy migration pathway for Li⁺-ions within the crystalline structure of this material was confirmed with DFT as well, the results of these calculations are provided in FIGS. 11G-11H. The low migration energy for Li⁺-ion hopping along the migration pathway in this material, coupled with its large bandgap, provide it ideal properties of a buffer layer to stabilize the solid-state electrolyte interface against lithium metal.

The combined approach of chemical composition characterization techniques and DFT calculations have elucidated the origin of the superior interfacial Li⁺-ion transfer for the CPE-05MC solid-state electrolyte relative to its counterpart. The small amount of Mg(ClO₄)₂ additive is enough to provoke the formation of a Li₂MgCl₄/LiF SEI. This layer effectively homogenizes the current density at the electrode/solid-state electrolyte interface during the stripping/plating process, which helps prevent the nucleation and growth of lithium dendrites. Moreover, the symmetric Li/CPE-05MC/Li cell experienced less polarization during cycling, indicating a good wettability of the electrolyte by the metallic lithium anode and a facile Li⁺-transfer across the electrode/electrolyte interface.

### All-Solid-State Li-Metal Battery Performance of CPE-05MC

With the stability of the CPE-05MC solid-state electrolyte against lithium metal confirmed, all-solid-state Li-metal batteries LiFePO₄ and LiNi_{0.8}Mn_{0.1}Co_{0.1}O₂ (NMC) were assembled to investigate the oxidative stability and Li⁺ transfer across the CPE-05MC/cathode interface. Additionally, full cell electrochemical testing allows for the performance benefits of the Li₂MgCl₄/LiF SEI layer to be confirmed for commercially relevant cathode materials. Although PEO is known to typically be incompatible with high voltage NMC cathodes, the use of a polyvinylidene difluoride (PVDF) coating on the active NMC particles and a slight increase of conductive carbon within the composite cathode increase the electronic and ionic conductivity for the composite cathode, providing protection for PEO-based polymer electrolyte with Li metal and a low interfacial resistance between the cathode and the solid-state electrolyte. The all-solid-state LiFePO₄/Li and NMC/Li cells showed a total resistance of 190 and 175Ω at 55° C., respectively (FIG. 13A and FIG. 14). The LiFePO₄/Li cell delivered a discharge capacity of 163, 157, 146, 140, 126 mAh g⁻¹ at current densities of 0.05, 0.1, 0.2, 0.4, 0.6 mA cm⁻² with an overpotential of 0.11, 0.16, 0.2, 0.31 and 0.41 V, respectively (FIG. 13B). The NMC/Li cell exhibited specific capacities of 145, 140, and 110 mAh g⁻¹ at current densities ranging from 0.1 to 0.3 mA cm⁻² (FIG. 13C) at 55° C.

The LiFePO₄/Li and NMC/Li cells delivered an initial Coulombic efficiency of 98.9% and 78.6% at 0.1 mA cm⁻² at 55° C., respectively. A discharge capacity of 110 mAh g⁻¹ obtained at 0.2 mA cm⁻² after 100 cycles with a high Coulombic efficiency above 99.1% (FIG. 13D) indicates good compatibility of the CPE-05MC with both electrodes in the Li/LiFePO₄ cell. Although the specific capacity of the NMC/Li cell began to degrade quickly when the current density was increased from 0.1 to 0.2 mAh cm⁻² during the long-term cycling test, it quickly recovered to 126 mAh g⁻¹ when the current density was set back to 0.1 mA cm⁻². The cell retained a specific capacity of 101.2 mAh g⁻¹ after 80 cycles (FIG. 13E). These results show that the CPE-05MC showed good ionic conductivity and stable interfacial performance in all-solid-state lithium metal batteries. Therefore, the formation of the Li₂MgCl₄/LiF SEI at the Li metal anode, which helps suppress dendrite formation, and the interfacial stability of the cathode/electrolyte interface, are beneficial to full-cell performance because they improve the Coulombic efficiency and capacity retention of the cells for long term cycling. Each of these performance metrics is instrumental in improving the cycle-life of all-solid-state lithium-metal batteries. These results show that a non-ionically conducting salt additive-even in concentrations as low as 0.5 wt %—can be an effective and easier implemented strategy to improve drastically the performance of all-solid-state lithium-metal batteries owing to their ability to tailor the SEI layer on a Li-metal anode, which dictates the ability to plate/stripe efficiently at high current density with a long cycle-life.

### CONCLUSION

In summary, the influence of Mg(ClO₄)₂ as an additive in PEO-LiTFSI electrolytes on battery performance was demonstrated. The addition of Mg(ClO₄)₂ improves the ionic conductivity of the composite polymer electrolyte as well as its stability against lithium metal by forming artificial interphase that is beneficial for Li⁺-transfer and uniform plating/stripping of lithium metal. The coordination of Mg²⁺ with the oxygen atoms from the TFSI⁻ anions, and ethers increases the total ionic conductivity of the composite electrolyte by increasing the concentration of mobile Li⁺ ions. The in-situ formed interphase between the Li-metal and the electrolyte is primarily composed of Li₂MgCl₄ and LiF, providing a low barrier for Li⁺-ion diffusion across the interface and stabilizing the interface upon repeated plating/stripping of lithium metal. The interfacial layer's capability to suppress lithium dendrite formation significantly increases the critical current density of the composite electrolyte to 2 mA cm⁻², which enables the cycling of all-solid-state Li-metal batteries with high Coulombic efficiency and stability. These results show the validity of simple additives, such as Mg(ClO₄)₂, as an effective strategy to improve the performance of polymer and polymer composite electrolytes to the levels needed for commercial all-solid-state batteries.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### ASPECTS

In view of the described electrodes, batteries, and methods and variations thereof, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.
Aspect 1: A solid-state ion-conducting composite electrolyte comprising: a) a polymer host; b) an alkali metal salt comprising a monovalent metal cation, wherein the alkali metal salt is dispersed in the polymer host; and c) a functional additive comprising at least one divalent and/or trivalent metal cation; wherein an ionic radius of the at least one divalent and/or trivalent metal cation of the functional additive is substantially similar to an ionic radius of the monovalent metal cation of the alkali metal salt; and wherein the functional additive is substantially dissolved within the polymer host; and wherein the solid-state ion-conducting composite electrolyte has an ionic conductivity of at least about 10⁻⁴ S/cm at room temperature.
Aspect 2: The solid-state ion-conducting composite electrolyte of Aspect 1, further comprising an inorganic filler present in an amount from greater than 0 wt % to about 30 wt % based on the weight of the polymer.
Aspect 3: The solid-state ion-conducting composite electrolyte of Aspect 2, wherein the inorganic filler comprises ceramic fillers, Al²O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, Li₃N, garnet Li₇La₃Zr₂O₁₂, perovskite Li_{0.33}La_{0.56}TiO₃, NASICON Li_{1.3}Al_{0.3} Tl_{1.7}(PO₄)₃, halide Li₃YCl₆, argyrodite Li₆PS₅Cl, or any combination thereof.
Aspect 4: The solid-state ion-conducting composite electrolyte of any one of Aspects 1-3, wherein the alkali metal salt is present in an amount from about 30 wt % to about 80 wt % based on the weight of the polymer.
Aspect 5: The solid-state ion-conducting composite electrolyte of any one of Aspects 1-4, wherein the functional additive is present in an amount from greater than 0 wt % to about 5 wt % based on the weight of the polymer.
Aspect 6: The solid-state ion-conducting composite electrolyte of any one of Aspects 1-5, wherein the polymer host comprises poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof.
Aspect 7: The solid-state ion-conducting composite electrolyte of any one of Aspects 1-6, wherein the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃ or a combination thereof.
Aspect 8: The solid-state ion-conducting composite electrolyte of any one of Aspects 1-7, wherein the at least one divalent and/or trivalent metal cation of the functional additive comprises one or more of Mg²⁺, Ba²⁺, Sc²⁺, Zn²⁺, Sn²⁺, Al³⁺, or Y³⁺.
Aspect 9: The solid-state ion-conducting composite electrolyte of any one of Aspects 1-8, wherein the at least one divalent and/or trivalent metal cation of the functional additive is immobile in the polymer host.
Aspect 10: The solid-state ion-conducting composite electrolyte of any one of Aspects 1-9, wherein the functional additive comprises a counter anion selected from halides, Cl⁻, ClO₄⁻, ClO₃⁻, I⁻, IO₃⁻, AlCl₄⁻, BCl₄⁻, BrO₃⁻, or a combination thereof.
Aspect 11: The solid-state ion-conducting composite electrolyte of any one of Aspects 1-10, wherein the monovalent metal cation of the alkali metal salt has a transference number from about 0.25 to about 0.4.
Aspect 12: The solid-state ion-conducting composite electrolyte of any one of Aspects 1-11, wherein the solid-state ion-conducting composite electrolyte exhibits an electronic conductivity of less than about 10⁻⁹ S cm⁻¹.
Aspect 13: The solid-state ion-conducting composite electrolyte of any one of Aspects 6-12, wherein the functional additive is configured to interact with one or more oxygen atoms present in the polymer host.
Aspect 14: The solid-state ion-conducting composite electrolyte of any one of Aspects 1-13, wherein the functional additive is configured to interact with one or more anions of the alkali metal salt.
Aspect 15: The solid-state ion-conducting composite electrolyte of any one of Aspects 1-14, wherein the solid-state ion-conducting composite electrolyte is substantially homogeneous.
Aspect 16: The solid-state ion-conducting composite electrolyte of any one of Aspects 1-15, wherein the solid-state ion-conducting composite electrolyte is substantially flexible.
Aspect 17: The solid-state ion-conducting composite electrolyte of any one of Aspects 1-16, wherein the composite electrolyte when used in an electrochemical cell allows obtaining a dendrite-free critical current density up to about 2 mA cm⁻² or up to 5 times higher when compared to a substantially identical reference solid-state electrolyte in the absence of the functional additive.
Aspect 18: The solid-state ion-conducting composite electrolyte of any one of Aspects 1-17, wherein the solid-state ion-conducting composite electrolyte, when used in an electrochemical cell, allows obtaining an areal capacity up to about 0.5 mAh cm⁻² or up to 5 times higher when compared to a substantially identical reference solid-state ion-conducting composite electrolyte in the absence of the functional additive
Aspect 19: The solid-state ion-conducting composite electrolyte of any one of Aspects 1-18, wherein the solid-state ion-conducting composite electrolyte is configured to operate in a temperature range from about 20° C. up to about 60° C.
Aspect 20: The solid-state ion-conducting composite electrolyte of any one of Aspects 1-19, wherein the solid-state ion-conducting composite electrolyte, when used in an electrochemical cell, allows obtaining a high charge-discharge Coulombic efficiency of the cell greater than about 99.1% for about 100 cycles.
Aspect 21: An electrochemical cell comprising: a) a metal anode comprising an electrochemically active surface; b) a solid-state ion-conducting composite electrolyte comprising: i) a polymer host; ii) an alkali metal salt comprising a monovalent metal cation, wherein the alkali metal salt is dispersed in the polymer host; and iii) a functional additive comprising at least one divalent and/or trivalent metal cation; wherein an ionic radius of the at least one divalent and/or trivalent metal cation of the functional additive is substantially similar to an ionic radius of the monovalent metal cation of the alkali metal salt; and wherein the functional additive is substantially dissolved within the polymer host; and wherein the solid-state ion-conducting composite electrolyte has an ionic conductivity of at least about 104 S/cm at room temperature; and wherein the ion-conductive composite electrolyte is flexible and is in electrical communication with the metal anode; and c) a solid electrolyte interphase layer formed in-situ and is disposed on the electrochemically active surface of the metal anode.
Aspect 22: The electrochemical cell of Aspect 21, wherein the metal anode comprises Li.
Aspect 23: The electrochemical cell of Aspect 21 or 212, wherein the solid-state ion-conducting composite electrolyte further comprises an inorganic filler present in an amount from greater than 0 wt % to about 30 wt % based on the weight of the polymer.
Aspect 24: The electrochemical cell of Aspect 23, wherein the inorganic filler comprises ceramic fillers, Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, Li₃N, garnet Li₇La₃Zr₂O₁₂, perovskite Li_{0.33}La_{0.56} TiO₃, NASICON Li_{1.3}Al_{0.3}Ti_{1.7}(PO₄)₃, halide Li₃YCl₆, argyrodite Li₆PS₅Cl, or any combination thereof.
Aspect 25: The electrochemical cell of any one of Aspects 21-24 wherein the alkali metal salt is present in an amount from about 30 wt % to about 80 wt % based on the weight of the polymer.
Aspect 26: The electrochemical cell of any one of Aspects 21-25, wherein the functional additive is present in an amount from greater than 0 wt % to about 5 wt % based on the weight of the polymer.
Aspect 27: The electrochemical cell of any one of Aspects 21-26, wherein the polymer host comprises poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof.
Aspect 28: The electrochemical cell of any one of Aspects 21-27, wherein the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, or a combination thereof.
Aspect 29: The electrochemical cell of any one of Aspects 21-28, wherein the at least one divalent and/or trivalent metal cation of the functional additive comprises one or more of Mg²⁺, Ba²⁺, Sc²⁺, Zn²⁺, Sn²⁺, Al³⁺, or Y³⁺.
Aspect 30: The electrochemical cell of any one of Aspects 21-29, wherein the at least one divalent and/or trivalent metal cation of the functional additive is immobile in the polymer host.
Aspect 31: The electrochemical cell of any one of Aspects 21-30, wherein the functional additive comprises a counter anion selected from halides, CI, ClO₄⁻, ClO₃⁻, I⁻, IO₃⁻, AlCl₄⁻, BCl₄⁻, BrO₃⁻, or a combination thereof.
Aspect 32: The electrochemical cell of any one of Aspects 21-31, wherein the monovalent metal cation of the alkali metal salt has a transference number from about 0.25 to about 0.4.
Aspect 33: The electrochemical cell of any one of Aspects 21-32, wherein the solid-state ion-conducting composite electrolyte exhibits an electronic conductivity of less than about 10⁻⁹ S cm⁻¹.
Aspect 34: The electrochemical cell of any one of Aspects 21-33, wherein the solid electrolyte interphase layer comprises at least one of halide or fluoride.
Aspect 35: The electrochemical cell of Aspect 34, wherein the solid electrolyte interphase layer is an electronic insulator, which exhibits an electrochemical window from 0 V to about 6.5 V vs. Li⁺/Li reference electrode.
Aspect 36: The electrochemical cell of Aspect 34 or 35, wherein the solid electrolyte interphase layer is formed in-situ and has a thickness from about 10 to about 100 nm.
Aspect 37: The electrochemical cell of any one of Aspects 34-36, wherein the solid electrolyte interphase layer exhibits a low Li⁺ diffusion barrier energy from 0 to about 0.8 eV.
Aspect 38: The electrochemical cell of Aspect 32 or 33, wherein the solid interphase layer exhibits an ionic conductivity of about 10⁻⁶ to about 10⁻⁴ S cm⁻¹.
Aspect 39: The electrochemical cell of any one of Aspects 21-38 further comprising a cathode.
Aspect 40: The electrochemical cell of Aspect 39, the cathode is a metal cathode or a composite cathode.
Aspect 41: The electrochemical cell of Aspect 40, wherein the cathode comprises a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode, or a metal Li cathode.
Aspect 42: The electrochemical cell of any one of Aspects 39-41, wherein the cathode comprises a poly(ethylene oxide), cellulose, carboxymethylcellulose (CMC), polytetrafluoroethylene (PTFE), styrene-butadiene rubber (SBR), or a polyvinylidene fluoride binder.
Aspect 43: The electrochemical cell of any one of Aspects 21-42 allowing to obtain a critical current density of about 0.4 to about 2 mA cm⁻².
Aspect 44: The electrochemical cell of any one of Aspects 20-43 exhibiting a high areal capacity from about 0.1 mAh cm⁻² to about 0.5 mAh cm⁻².
Aspect 45: The electrochemical cell of any one of Aspects 21-44 capable of providing a substantially stable plating at about 0.1 mA cm⁻² for up to about 30 h.
Aspect 46: The electrochemical cell of any one of Aspects 40-45, wherein the cell exhibits a cyclic Coulombic efficiency greater than about 99.1% for about 100 cycles.
Aspect 47: The electrochemical cell of any one of Aspects 40-46, wherein the cell exhibits a substantial discharge capacity retention greater than about 70% after about 100 stripping/plating cycles.
Aspect 48: A battery comprising the electrochemical cell of any one of Aspects 21-47.
Aspect 49: The battery of Aspect 48, wherein the battery is a secondary battery.
Aspect 50: A method comprising: a) forming a mixture of a polymer host, an alkali metal salt, and a functional additive in a solvent, wherein the alkali metal salt comprises a monovalent cation; wherein the functional additive comprises at least one divalent and/or trivalent metal cation and wherein an ionic radius of the metal cation of the functional additive is substantially similar to an ionic radius of the monovalent metal cation of the alkali metal salt, and b) removing the solvent to form a flexible solid-state ion-conducting composite electrolyte comprising the alkali metal salt and the functional additive that is substantially dispersed within the polymer host; wherein the flexible solid-state ion-conducting composite electrolyte has an ionic conductivity of at least about 10⁻⁴ S/cm at room temperature.
Aspect 51: The method of Aspect 50, wherein the mixture further comprises an inorganic filler in an amount greater than 0 wt % to about 30 wt % based on the weight of the polymer.
Aspect 52: The method of Aspect 51, wherein the inorganic filler comprises ceramic fillers, Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, Li₃N, garnet Li₇La₃Zr₂O₁₂, perovskite Li_{0.33}La_{0.56} TiO₃, NASICON Li_{1.3}Al_{0.3}Ti_{1.7}(PO₄)₃, halide Li₃YCl₆, argyrodite Li₆PS₅Cl, or any combination thereof.
Aspect 53: The method of any one of Aspects 50-52, wherein the alkali metal salt is present in an amount from about 30 wt % to about 80 wt % based on the weight of the polymer.
Aspect 54: The method of any one of Aspects 50-53, wherein the functional additive is present in an amount from greater than 0 wt % to about 5 wt % based on the weight of the polymer.
Aspect 55: The method of any one of Aspects 50-54, wherein the polymer host comprises poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof.
Aspect 56: The method of any one of Aspects 50-55, wherein the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, or a combination thereof.
Aspect 57: The method of any one of Aspects 50-56, wherein the at least one divalent and/or trivalent metal cation of the functional additive comprises one or more of Mg²⁺, Ba²⁺, Sc²⁺, Zn²⁺, Sn²⁺, Al³⁺, or Y³⁺.
Aspect 58: The method of any one of Aspects 50-57, wherein the at least one divalent and/or trivalent metal cation of the functional additive is immobile in the polymer host.
Aspect 59: The method of any one of Aspects 50-58, wherein the functional additive comprises a counter anion selected from halides, Cl⁻, ClO₄⁻, ClO₃⁻, I⁻, IO₃⁻, AlCl₄⁻, BCl₄⁻, BrO₃⁻, or a combination thereof.
Aspect 60: The method of any one of Aspects 50-59, wherein the monovalent metal cation of the alkali metal salt has a transference number from about 0.25 to about 0.4.
Aspect 61: The method of any one of Aspects 50-60, wherein the solid-state ion-conducting composite electrolyte exhibits an electronic conductivity of less than about 10⁻⁹ S cm⁻¹.
Aspect 62: The method of any one of Aspects 50-61, wherein the functional additive is configured to interact with one or more oxygen atoms present in the polymer host.
Aspect 63: The method of any one of Aspects 50-62, wherein the functional additive is configured to interact with one or more anions of the alkali metal salt.
Aspect 64: The method of any one of Aspects 50-63, wherein the solid-state ion-conducting composite electrolyte is substantially homogeneous.
Aspect 65: The method of any one of Aspects 50-64, wherein the solid-state ion-conducting composite electrolyte is substantially flexible.
Aspect 66: The method of any one of Aspects 50-65, wherein the solid-state ion-conducting composite electrolyte, when used in an electrochemical cell, allows obtaining a dendrite-free critical current density up to about 2 mA cm⁻² or up to 5 times higher when compared to a substantially identical reference solid-state ion-conducting electrolyte in the absence of the functional additive.
Aspect 67: The method of any one of Aspects 50-66, wherein the solid-state ion-conducting composite electrolyte when used in an electrochemical cell allows obtaining an areal capacity up to about 0.5 mAh cm⁻² or up to 5 times higher when compared to a substantially identical reference solid-state ion-conducting electrolyte in the absence of the functional additive.
Aspect 68: The method of any one of Aspects 50-68, wherein the solid-state ion-conducting composite electrolyte is configured to operate in a temperature range from about 20° C. up to about 60° C.
Aspect 69: The method of any one of Aspects 50-69, wherein the solid-state ion-conducting composite electrolyte, when used in an electrochemical cell, allows obtaining a high charge-discharge Coulombic efficiency of greater than about 99.1% for about 100 cycles.
Aspect 70: A method of forming a battery comprising: disposing the solid-state ion-conducting composite electrolyte of any one of Aspects 1-20 between an electrochemically active surface of a metal anode and a cathode.
Aspect 71: The method of Aspect 70, wherein the metal anode comprises Li.
Aspect 72: The method of Aspect 70 or 71, wherein the cathode is a metal cathode or a composite cathode.
Aspect 73: The method of Aspect 72, wherein the cathode comprises a LiFePO₄ composite cathode, a LiNi_{0.8}CO_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode, or a metal Li cathode.
Aspect 74: The method of any one of Aspects 72-73, wherein the cathode comprises a poly(ethylene oxide), cellulose, carboxymethylcellulose (CMC), polytetrafluoroethylene (PTFE), styrene-butadiene rubber (SBR), or a polyvinylidene fluoride binder.
Aspect 75: The method of any one of Aspects 70-74, wherein a solid electrolyte interphase layer is formed in-situ and is disposed on the electrochemically active surface of the metal anode.
Aspect 76: The method of Aspect 75, wherein the solid electrolyte interphase layer is an electronic insulator exhibiting low Li⁺ diffusion barrier energy.
Aspect 77: The method of any one of Aspects 70-76, wherein the battery exhibits a critical current density of about 0.4 to about 2 mA cm⁻².
Aspect 78: The method of any one of Aspects 70-77, wherein the battery exhibiting a high areal capacity from about 0.1 mAh cm⁻² to about 0.5 mAh cm⁻².
Aspect 79: The method of any one of Aspects 70-78, wherein the battery is capable of providing a substantially stable plating at about 0.1 mA cm⁻² for up to about 30 h.
Aspect 80: The method of any one of Aspects 70-79, wherein the battery exhibits a cyclic Coulombic efficiency greater than about 99.1% for about 100 cycles.
Aspect 81: The method of any one of Aspects 70-80, wherein the battery exhibits a substantial discharge capacity retention greater than about 70% after about 100 stripping/plating cycles.

### REFERENCES

(1) Larcher, D.; Tarascon, J. M. Towards greener and more sustainable batteries for electrical energy storage. Nat. Chem. 7, 19-29 (2015).
(2) Zhang. Y.; He, X.; Chen, Z.; Bai, Q.; Nolan, A. M.; Roberts, C. A.; Banerjee, D.; Matsunaga, T.; Mo, Y.; Ling, C. Unsupervised discovery of solid-state lithium-ion conductors. Nat. Commun. 10, 5260 (2019).
(3) Kato, Y.; Hori, S.; Saito, T.; Suzuki, K., Hirayama, M.; Mitsui, A.; Yonemura, M.; Iba, H.; Kanno, R. High-power all-solid-state batteries using sulfide superionic conductors. Nat. Energy 1, 16030 (2016).
(4) Famprikis, T.; Canepa, P.; Dawson, J. A.; Islam, M. S., Masquelier, C. Fundamentals of inorganic solid-state electrolytes for batteries. Nat. Mater. 18, 1278-1291 (2019).
(5) Manalastas, W.; Rikarte, J.; Chater, R. J.; Brugge, R.; Aguadero, A.; Buannic, L.; Llordés, A.; Aguesse, F.; Kilner, J. Mechanical failure of garnet electrolytes during Li electrodeposition observed by in-operando microscopy. J. Power Sources 412, 287-293 (2019).
(6) Koerver, R.; Zhang, W.; de Biasi, L.; Schweidler, S.; Kondrakov, A. O.; Kolling, S.; Brezesinski, T.; Hartmann, P.; Zeier, W. G.; Janek, J. Chemo-mechanical expansion of lithium electrode materials-on the route to mechanically optimized all-solid-state batteries. Energy Environ. Sci. 11, 2142-2158 (2018).
(7) Koshikawa, H.; Matsuda, S.; Kamiya, K.; Miyayama, M.; Kubo, Y.; Uosaki, K.; Hashimoto, K.; Nakanishi, S. Dynamic changes in charge-transfer resistance at Li metal/Li₇La₃Zr₂O₁₂ interfaces during electrochemical Li dissolution/deposition cycles. J. Power Sources 376, 147-151 (2018).
(8) Krauskopf, T.; Hartmann, H.; Zeier, W. G.; Janek, J. Toward a Fundamental Understanding of the Lithium Metal Anode in Solid-State Batteries-An Electrochemo-Mechanical Study on the Garnet-Type Solid Electrolyte Li_{6.25}Al_{0.25}La₃Zr₂O₁₂. ACS Appl. Mater. Interfaces 11, 14463-14477 (2019).
(9) Kasemchainan, J.; Zekoll, S.; Spencer Jolly, D., Ning, Z.; Hartley, G. O.; Marrow. J.; Bruce, P. G. Critical stripping current leads to dendrite formation on plating in lithium anode solid electrolyte cells. Nat. Mater. 18, 1105-1111 (2019).
(10) Wang, H.; Sheng, L.; Yasin, G.; Wang, L.; Xu, H.; He, X. Reviewing the current status and development of polymer electrolytes for solid-state lithium batteries. Energy Storage Materials 33, 188-215 (2020).
(11) Liu, Y.; Lin, D.; Jin, Y.; Liu, K.; Tao, X.; Zhang, Q.; Zhang, X.; Cui, Y. Transforming from planar to three-dimensional lithium with flowable interphase for solid lithium metal batteries. Sci. Adv. 3, eaao0713 (2017).
(12) Wu, N.; Chien, P. H.; Qian, Y.; Li, Y.; Xu, H.; Grundish, N. S.; Xu, B.; Jin, H.; Hu, Y. Y.; Yu, G.; Goodenough, J. B. Enhanced Surface Interactions Enable Fast Li⁺ Conduction in Oxide/Polymer Composite Electrolyte. Angew. Chem. Int. Ed. Engl. 59, 4131-4137 (2020).
(13) Xu, H., Chien, P. H.; Shi, J., Li, Y.; Wu, N.; Liu, Y.; Hu, Y. Y., Goodenough, J. B. High-performance all-solid-state batteries enabled by salt bonding to perovskite in poly(ethylene oxide). Proc. Natl. Acad. Sci. USA 116, 18815-18821 (2019).
(14) Chen, H.; Adekoya, D.; Hencz, L.; Ma, J.; Chen, S.; Yan, C.; Zhao, H.; Cui, G.; Zhang, S. Stable Seamless Interfaces and Rapid Ionic Conductivity of Ca-CeOz/LiTFSI/PEO Composite Electrolyte for High-Rate and High-Voltage All-Solid-State Battery. Adv. Energy Mater. 10, 2000049 (2020).
(15) Ye, F.; Liao, K.; Ran, R.; Shao, Z. Recent Advances in Filler Engineering of Polymer Electrolytes for Solid-State Li-Ion Batteries: A Review. Energy & Fuels 34, 9189-9207 (2020).
(16) Cheng, Z.; Liu, T., Zhao, B.; Shen, F.; Jin, H.; Han, X. Recent advances in organic-inorganic composite solid electrolytes for all-solid-state lithium batteries. Energy Storage Materials 34, 388-416 (2021)
(17) Kumar, Y.; Hashmi, S. A.; Pandey, G. P. Ionic liquid mediated magnesium ion conduction in poly(ethylene oxide) based polymer electrolyte. Electrochimica Acta 56, 3864-3873 (2011).
(18) Xue, Z.; He, D., Xie, X. Poly(ethylene oxide)-based electrolytes for lithium-ion batteries. J. Mater. Chem. A 3, 19218-19253 (2015).
(19) Jaipal Reddy, M.; Chu, P. P. Ion pair formation and its effect in PEO: Mg solid polymer electrolyte system. J. Power Sources 109, 340-346 (2002).
(20) Bakker, A.; Gejji, S.; Lindgren, J.; Hermansson, K.; Probst, M. M. Contact ion pair formation and ether oxygen coordination in the polymer electrolytes M[N(CF₃SO₂)₂]₂PEOₙ for M=Mg, Ca, Sr and Ba. Polymer 36, 4371-4378 (1995).
(21) Wang, C.; Yang, Y.; Liu, X.; Zhong, H.; Xu, H.; Xu, Z.; Shao, H.; Ding, F. Suppression of lithium dendrite formation by using LAGP-PEO (LiTFSI) composite solid electrolyte and lithium metal anode modified by PEO (LiTFSI) in all-solid-state lithium batteries. ACS Appl. Mater. Interfaces 9, 13694-13702 (2017).
(22) Lima, V.; Seidl, T.; Hossain, U. H.; Baake, O.; Severin, D.; Bender, M.; Trautmann, C.; Ensinger, W. Degradation of polyethylene oxides during irradiation with uranium ions. GSI Sci. Rep 21, 389 (2010)
(23) Rey, I.; Lassègues, J. C.; Grondin, J.; Servant, L. Infrared and Raman study of the PEO-LiTFSI polymer electrolyte. Electrochimica Acta 43, 1505-1510 (1998).
(24) Dissanayake, M. A. K. L.; Bandara, L. R. A. K.; Karaliyadda, L. H.; Jayathilaka, P. A. R. D.; Bokalawala, R. S. P. Thermal and electrical properties of solid polymer electrolyte PEO₉ Mg(ClO₄)₂ incorporating nano-porous Al₂O₃ filler. Solid State Ionics 177, 343-346 (2006).
(25) Dai, Y.; Greenbaum, S.; Golodnitsky, D.; Ardel, G.; Strauss, E.; Peled, E.; Rosenberg, Y. Lithium-7 NMR studies of concentrated Lil/PEO-based solid electrolytes. Solid State Ionics 106, 25-32 (1998).
(26) Lauenstein, Å.; Tegenfeldt, J. Chain Mobility and Cation Coordination in the Polymer Electrolytes M[N(CF₃SO₂)₂]₂PEOₙ with M=Mg, Ca, Sr, and Ba. J Phys. Chem. B 102, 6702-6709 (1998).
(27) Wu. N.; Chien, P. H.; Li, Y.; Dolocan, A.; Xu, H.; Xu, B.; Grundish, N. S.; Jin, H.; Hu, Y. Y.; Goodenough, J. B. Fast Li⁺ Conduction Mechanism and Interfacial Chemistry of a NASICON/Polymer Composite Electrolyte. J. Am. Chem. Soc. 142, 2497-2505 (2020).
(28) Zheng, J.; Dang, H.; Feng, X.; Chien, P.-H.; Hu, Y.-Y. Li-ion transport in a representative ceramic-polymer-plasticizer composite electrolyte: Li₇La₃Zr₂O₁₂-polyethylene oxide-tetraethylene glycol dimethyl ether. J. Mater. Chem. A 5, 18457-18463 (2017).
(29) Watkins. T.; Buttry, D. A. Determination of Mg²⁺ Speciation in a TFSI⁻-Based Ionic Liquid With and Without Chelating Ethers Using Raman Spectroscopy. J. Phys. Chem. B 119, 7003-14 (2015)
(30) Diddens, D.; Heuer, A. Simulation study of the lithium ion transport mechanism in ternary polymer electrolytes: the critical role of the segmental mobility. J. Phys. Chem. B 118, 1113-25 (2014).
(31) Lapidus, S. H.; Rajput, N. N.; Qu, X.; Chapman, K. W.; Persson, K. A.; Chupas, P. J. Solvation structure and energetics of electrolytes for multivalent energy storage. Phys. Chem. Chem. Phys. 16, 21941-5 (2014).
(32) Terada, S.; Mandai, T.; Suzuki, S.; Tsuzuki, S.; Watanabe, K.; Kamei, Y.; Ueno, K.; Dokko, K.; Watanabe, M. Thermal and Electrochemical Stability of Tetraglyme-Magnesium Bis(trifluoromethanesulfonyl)amide Complex: Electric Field Effect of Divalent Cation on Solvate Stability. J. Phys. Chem. C 120, 1353-1365 (2016).
(33) Borodin, O.; Giffin, G. A., Moretti, A., Haskins, J. B.; Lawson, J. W.; Henderson, W. A.; Passerini, S. Insights into the Structure and Transport of the Lithium, Sodium, Magnesium, and Zinc Bis(trifluoromethansulfonyl)imide Salts in Ionic Liquids. J. Phys. Chem. C 122, 20108-20121 (2018).
(34) Hanson, B.; Pryamitsyn, V.; Ganesan, V. Mechanisms Underlying Ionic Mobilities in Nanocomposite Polymer Electrolytes. ACS Macro Letters 2, 1001-1005 (2013).
(35) Sun, F.; Zielke, L.; Markotter, H.; Hilger, A.; Zhou, D.; Moroni, R.; Zengerle, R.; Thiele, S.; Banhart, J.; Manke, I. Morphological Evolution of Electrochemically Plated/Stripped Lithium Microstructures Investigated by Synchrotron X-ray Phase Contrast Tomography. ACS Nano 10, 7990-7 (2016).
(36) Advanced Functional MaterialsSun, F.; Dong, K., Osenberg, M.; Hilger, A.; Risse, S.; Lu, Y.; Kamm, P. H.; Klaus, M.; Markötter, H.; García-Moreno, F.; Arlt, T.; Manke, I. Visualizing the morphological and compositional evolution of the interface of InLi-anode|thio-LISION electrolyte in an all-solid-state Li—S cell by in operando synchrotron X-ray tomography and energy dispersive diffraction. J. Mater. Chem. A 6, 22489-22496 (2018).
(37) Fan, X.; Chen, L.; Ji, X.; Deng, T.; Hou, S.; Chen, J.; Zheng, J.; Wang, F.; Jiang, J.; Xu, K.; Wang, C. Highly Fluorinated Interphases Enable High-Voltage Li-Metal Batteries. Chem 4, 174-185 (2018).
(38) Fan, X.; Ji, X.; Han, F.; Yue, J.; Chen, J.; Chen, L.; Deng, T.; Jiang, J.; Wang, C. Fluorinated solid electrolyte interphase enables highly reversible solid-state Li metal battery. Sci. Adv. 4, eaau9245 (2018).
(39) Chen, Y. C.; Ouyang, C. Y.; Song, L. J.; Sun, Z. L. Electrical and Lithium Ion Dynamics in Three Main Components of Solid Electrolyte Interphase from Density Functional Theory Study. J. Phys. Chem. C 115, 7044-7049 (2011).
(40) Kanno, R.; Takeda, Y.; Takeda, K.; Yamamoto, O. Ionic conductivity and phase transition of the spinel system Li₂₋₂ₓM₁₊ₓCl₄ (M=Mg, Mn, Cd). J. Electrochem. Sci. 131, 469-474 (1984).
(41) Qiu, J.; Liu, X.; Chen, R.; Li, Q.; Wang, Y.; Chen, P.; Gan, L.; Lee, S. J.; Nordlund, D.; Liu, Y.; Yu, X.; Bai, X.; Li, H.; Chen, L. Enabling Stable Cycling of 4.2 V High-Voltage All-Solid-State Batteries with PEO-Based Solid Electrolyte. Adv. Funct. Mater. 30, 1909392 (2020).
(42) Li, Z.; Li, A.; Zhang, H.; Lin, R.; Jin, T.; Cheng, Q.; Xiao, X.; Lee, W.-K.; Ge, M.; Zhang, H.; Zangiabadi, A.; Waluyo, I.; Hunt, A.; Zhai, H.; Borovilas, J. J.; Wang, P.; Yang, X.-Q.; Chuan, X.; Yang, Y. Interfacial engineering for stabilizing polymer electrolytes with 4V cathodes in lithium metal batteries at elevated temperature. Nano Energy 72, 104655 (2020).
(43) Wu, H.; Xu, Y.; Ren, X.; Liu, B.; Engelhard, M. H.; Ding, M. S.; El-Khoury, P. Z.; Zhang, L., Li, Q.; Xu, K., Wang, C.; Zhang, J. G.; Xu, W. Polymer-in-“Quasi-Ionic Liquid” Electrolytes for High-Voltage Lithium Metal Batteries. Adv. Energy Mater. 9, 1902108 (2019).
(44) Dong, K.; Osenberg, M.; Sun, F.; Markötter, H.; Jafta, C. J.; Hilger, A.; Arlt, T.; Banhart, J.; Manke, I. Non-destructive characterization of lithium deposition at the Li/separator and Li/carbon matrix inter-region by synchrotron X-ray tomography. Nano Energy 62, 11-19 (2019).
(45) Schindelin, J.; Arganda-Carreras, I.; Frise, E.; Kaynig, V.; Longair, M., Pietzsch, T.; Preibisch, S.; Rueden, C.; Saalfeld, S.; Schmid, B.; Tinevez, J. Y.; White, D. J.; Hartenstein, V.; Eliceiri, K.; Tomancak, P.; Cardona, A. Fiji: an open-source platform for biological-image analysis. Nat. Methods 9, 676-82 (2012).
(46) Plimpton, S. Fast Parallel Algorithms for Short-Range Molecular Dynamics. J. Comput. Phys. 117, 1-19 (1995).
(47) Kubisiak, P.; Eilmes, A. Solvation of Mg²⁺ Ions in Mg(TFSI)₂—Dimethoxyethane Electrolytes—A View from Molecular Dynamics Simulations. J. Phys. Chem. C 122, 12615-12622 (2018).
(48) Martinez, L.; Andrade, R.; Birgin, E. G., Martinez, J. M. PACKMOL: a package for building initial configurations for molecular dynamics simulations. J. Comput. Chem. 30, 2157-64 (2009).
(49) Blochl, P. E. Projector augmented-wave method. Phys. Rev. B Condens. Matter. 50, 17953-17979 (1994).
(50) Kresse, G.; Joubert, D. From ultrasoft pseudopotentials to the projector augmented-wave method. Phys. Rev. B 59, 1758-1775 (1991).
(51) Kresse, G.; Hafner, J. Ab initio molecular-dynamics simulation of the liquid-metal-amorphous-semiconductor transition in germanium. Phys. Rev. B Condens. Matter. 49, 14251-14269 (1994).
(52) Kresse, G.; Furthmüller, J. Efficient iterative schemes for ab initio total-energy calculations using a plane-wave basis set. Physical Review B 54, 11169-11186 (1996).
(53) Mathew, K.; Sundararaman, R.; Letchworth-Weaver, K.; Arias, T. A.; Hennig, R. G. Implicit solvation model for density-functional study of nanocrystal surfaces and reaction pathways. J. Chem. Phys. 140, 084106 (2014).
(54) Ekanayake, P.; Dissanayake, M. A. K. L. Effect of nanoporous alumina filler on conductivity enhancement in PEO₉ (MgClO₄)₂ polymer electrolyte: a 1H NMR study. J. Solid State Electrochem. 13, 1825-1829 (2008).
(55) Yoshimoto, N.; Tomonaga, Y.; Ishikawa M.; Morita M. Ionic conductance of polymer electrolytes consisting of magnesium salts dissolved in a cross-linked polymer matrix with linear polyether. Electrochimica Acta 46, 1195-1200 (2001).
(56) Yoon, S.; Lee, J.; Kim, S.-O.; Sohn, H.-J. Enhanced cyclability and surface characteristics of lithium batteries by Li—Mg co-deposition and addition of HF acid in the electrolyte. Electrochimica Acta 53, 2501-2506 (2008).

1. A solid-state ion-conducting composite electrolyte comprising:
a) a polymer host;
b) an alkali metal salt comprising a monovalent metal cation, wherein the alkali metal salt is dispersed in the polymer host; and
c) a functional additive comprising at least one divalent and/or trivalent metal cation;
wherein an ionic radius of the at least one divalent and/or trivalent metal cation of the functional additive is substantially similar to an ionic radius of the monovalent metal cation of the alkali metal salt; and
wherein the functional additive is substantially dissolved within the polymer host; and
wherein the solid-state ion-conducting composite electrolyte has an ionic conductivity of at least about 10⁻⁴ S/cm at room temperature.

2. The solid-state ion-conducting composite electrolyte of claim 1, further comprising an inorganic filler present in an amount from greater than 0 wt % to about 30 wt % based on the weight of the polymer host.

3. The solid-state ion-conducting composite electrolyte of claim 2, wherein the inorganic filler comprises ceramic fillers, Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, Li₃N, garnet Li₇La₃Zr₂O₁₂, perovskite Li_{0.33}La_{0.56}TiO₃, NASICON Li_{1.3}Al_{0.3}Ti_{1.7}(PO₄)₃, halide Li₃YCl₆, argyrodite Li₆PS₅Cl, or any combination thereof.

4. The solid-state ion-conducting composite electrolyte of claim 1, wherein the alkali metal salt is present in an amount from about 30 wt % to about 80 wt % based on the weight of the polymer host.

5. The solid-state ion-conducting composite electrolyte of claim 1, wherein the functional additive is present in an amount from greater than 0 wt % to about 5 wt % based on the weight of the polymer host.

6. The solid-state ion-conducting composite electrolyte of claim 1, wherein the polymer host comprises poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof.

7. The solid-state ion-conducting composite electrolyte of claim 1, wherein the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, or a combination thereof.

8. The solid-state ion-conducting composite electrolyte of claim 1, wherein the at least one divalent and/or trivalent metal cation of the functional additive comprises one or more of Mg²⁺, Ba²⁺, Sc²⁺, Zn²⁺, Sn²⁺, Al³⁺, or Y³⁺.

9. The solid-state ion-conducting composite electrolyte of claim 1, wherein the at least one divalent and/or trivalent metal cation of the functional additive is immobile in the polymer host.

10. The solid-state ion-conducting composite electrolyte of claim 1, wherein the functional additive comprises a counter anion selected from halides, Cl⁻, ClO₄⁻, ClO₃⁻, I⁻, IO₃⁻, AlCl₄⁻, BCl₄⁻, BrO₃⁻, or a combination thereof.

11. The solid-state ion-conducting composite electrolyte of claim 1, wherein the monovalent metal cation of the alkali metal salt has a transference number from about 0.25 to about 0.4.

12. The solid-state ion-conducting composite electrolyte of claim 1, wherein the solid-state ion-conducting composite electrolyte exhibits an electronic conductivity of less than about 10⁻⁹ S cm⁻¹.

13. The solid-state ion-conducting composite electrolyte of claim 1, wherein the functional additive is configured to interact with one or more oxygen atoms present in the polymer host.

14. The solid-state ion-conducting composite electrolyte of claim 1, wherein the functional additive is configured to interact with one or more anions of the alkali metal salt.

15. The solid-state ion-conducting composite electrolyte of claim 1, wherein the solid-state ion-conducting composite electrolyte is substantially homogeneous.

16. The solid-state ion-conducting composite electrolyte of claim 1, wherein the solid-state ion-conducting composite electrolyte is substantially flexible.

17. The solid-state ion-conducting composite electrolyte of claim 1, wherein the solid-state ion-conducting composite electrolyte when used in an electrochemical cell allows obtaining a dendrite-free critical current density up to about 2 mA cm⁻² or up to 5 times higher when compared to a substantially identical reference solid-state ion-conducting composite electrolyte in the absence of the functional additive.

18. The solid-state ion-conducting composite electrolyte of claim 1, wherein the solid-state ion-conducting composite electrolyte, when used in an electrochemical cell, allows obtaining an areal capacity up to about 0.5 mAh cm⁻² or up to 5 times higher when compared to a substantially identical reference solid-state ion-conducting composite electrolyte in the absence of the functional additive.

19. The solid-state ion-conducting composite electrolyte of claim 1, wherein the solid-state ion-conducting composite electrolyte is configured to operate in a temperature range from about 20° C. up to about 60° C.

20. The solid-state ion-conducting composite electrolyte of claim 1, wherein the solid-state ion-conducting composite electrolyte, when used in an electrochemical cell, allows obtaining a high charge-discharge Coulombic efficiency of the electrochemical cell greater than about 99.1% for about 100 cycles.

21.-81. (canceled)
